(19) United States
(12) Patent Application Publication
(10) Pub. No.: US 2008/0032067 A1
(43) Pub. Date: Feb. 7, 2008

(54) Cellulose acylate film, and polarizing plate and liquid crystal display device using the same

(75) Inventors: Mamoru Sakurazawa, Kanagawa (JP); Akihiro Matsufuji, Kanagawa (JP); Yasuo Mukunoki, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/878,313

(22) Filed: Jul. 23, 2007

(30) Foreign Application Priority Data
Jul. 24, 2006 (JP) 2006-200779

(51) Int. Cl. C08L 1/10; B32B 27/06; C09K 19/00

(52) U.S. Cl. 428/1.5; 428/220; 524/37

(57) ABSTRACT

A cellulose acylate film includes a cellulose acylate, a polymer obtained by polymerizing an ethylenically unsaturated monomer and an unreacted ethylenically unsaturated monomer in an amount of 1 mass % or less based on the cellulose acylate film.

### BACKGROUND OF THE INVENTION

1. Field of the Invention

The present invention relates to a cellulose acylate film, and a polarizing plate and a liquid crystal display device each using the cellulose acylate film.

2. Description of the Related Art

A cellulose acylate film has been conventionally used for photographic supports or various optical materials because of its toughness and flame retardancy. In particular, usage as an optical transparent film for liquid crystal display devices is recently increased. By virtue of high optical transparency and high optical isotropy, the cellulose acylate film is excellent as an optical material for devices utilizing polarizing light, such as liquid crystal display device, and has been so far used as a protective film of a polarizer or as a support of an optically-compensatory film capable of making better the display viewed from an oblique direction (viewing angle compensation).

In recent liquid crystal display devices, improvement of viewing angle characteristics is more strongly demanded and the optical transparent film such as protective film of a polarizer or support of an optically-compensatory film is required to be more optically isotropic. In order to be optically isotropic, it is important that the retardation value denoted by the product of birefringence and thickness of the optical film is small. Particularly, for making better the display viewed from an oblique direction, not only the in-plane retardation (Re) but also the retardation (Rth) in the thickness direction need to be small. More specifically, it is required that at the evaluation of optical characteristics of an optical transparent film, Re measured in front of the film is small and even when measured by changing the angle, Re does not change.

A cellulose acylate film with small in-plane Re has been heretofore known, but a cellulose acylate film with little Re change depending on the angle, that is, with small Rth, is difficult to produce. An optically isotropic optical transparent film where the in-plane Re of the cellulose acylate film is nearly zero and the change of retardation depending on angle is small, that is, Rth is also nearly zero, is strongly demanded.

In the production of the cellulose acylate film, a compound called a plasticizer is generally added for enhancing the film-forming performance. As for the kind of the plasticizer, there are phosphoric acid triesters such as phosphoric acid triphenyl and biphenyl-diphenyl phosphate; and phthalic acid esters. Some of these plasticizers are known to have an effect of decreasing the optical anisotropy of the cellulose acylate film (for example, a specific fatty acid ester; see, JP-A-2001-247717 (the term “JP-A” as used herein means an “unexamined published Japanese patent application”)), but the effect of decreasing the optical anisotropy of the cellulose acylate film is not sufficiently high.

Also, it is disclosed that when a polymer obtained by polymerizing an ethylenically unsaturated monomer mainly comprising a monomer selected from a vinyl ester and an acrylic acid ester is incorporated into a cellulose ester film, the defects or foreign matters of the polarizing plate protective film can be removed and generation of white spots on the edge of the polarizing plate under high-temperature high-humidity conditions can be reduced (see, JP-A-2002-20410). Furthermore, it is disclosed that a protective film for polarizing plates, comprising a cellulose ester containing a polyester has excellent dimensional stability (see, for example, JP-A-2002-22956). However, outdoor usage of a liquid crystal display device, such as mobile and in-car use, is recently increasing and higher stability of the polarizing plate performance under high-temperature high-humidity conditions becomes important.

### SUMMARY OF THE INVENTION

The present invention provides a cellulose acylate film having small optical anisotropy (Re, Rth), and an excellent polarizing plate using the same, which is assured of less deterioration of the polarizer in aging of a long time under a high-humidity condition.

As a result of intensive studies by the present inventors, the object of the present invention has been attained by the cellulose acylate film described below.

[1] A cellulose acylate film comprising:

a cellulose acylate;

a polymer obtained by polymerizing an ethylenically unsaturated monomer; and

an unreacted ethylenically unsaturated monomer in an amount of 1 mass % or less based on the cellulose acylate film.

[2] The cellulose acylate film as described in [1],

wherein the polymer is an acrylic polymer.

[3] A cellulose acylate film comprising:

a cellulose acylate;

a condensation polymer selected from the group consisting of a condensation polymer obtained by polycondensing an organic acid, a glycol and a monohydric alcohol and a condensation polymer obtained by polycondensing an organic acid and a glycol; and

a low-molecular ester compound in an amount of 1 mass % or less based on the cellulose acylate film,

wherein the low-molecular ester compound is obtained by condensing five or less molecules which are raw materials of the condensation polymer.

[4] The cellulose acylate film as described in [1], further comprising:

an ultraviolet absorbent that is in a liquid state at 25° C.

[5] The cellulose acylate film as described in [3], further comprising:

an ultraviolet absorbent that is in a liquid state at 25° C.

[6] The cellulose acylate film as described in [1],

wherein the cellulose acylate has an acyl substitution degree of 2.50 to 3.00 and an average polymerization degree of 180 to 700.

[7] The cellulose acylate film as described in [3],

wherein the cellulose acylate has an acyl substitution degree of 2.50 to 3.00 and an average polymerization degree of 180 to 700.

[8] The cellulose acylate film as described in [1],

wherein substantially all acyl substituents of the cellulose acylate are acetyl groups; and

the cellulose acylate has an acyl substitution degree of 2.50 to 2.95 and an average polymerization degree of 180 to 550.

[9] The cellulose acylate film as described in [3],

wherein substantially all acyl substituents of the cellulose acylate are acetyl groups; and

the cellulose acylate has an acyl substitution degree of 2.50 to 2.95 and an average polymerization degree of 180 to 550.

[10] The cellulose acylate film as described in [1], which has a thickness of from 10 to 120 μm.

[11] The cellulose acylate film as described in [3], which has a thickness of from 10 to 120 μm.

[12] The cellulose acylate film as described in [1], which satisfies the following formulae (1) and (2):
−25 nm≦Rth(630)≦25 nm Formula (1):
0 nm≦Re(630)≦10 nm, Formula (2):

wherein Rth(630) represents a retardation in a thickness direction of the cellulose acylate film at a wavelength of 630 nm; and

Re(630) represents an in-plane retardation of the cellulose acylate film at a wavelength of 630 nm.

[13] The cellulose acylate film as described in [3], which satisfies the following formulae (1) and (2):
−25 nm≦Rth(630)≦25 nm Formula (1):
0 nm≦Re(630)≦10 nm, Formula (2):

wherein Rth(630) represents a retardation in a thickness direction of the cellulose acylate film at a wavelength of 630 nm; and

Re(630) represents an in-plane retardation of the cellulose acylate film at a wavelength of 630 nm.

[14] A polarizing plate comprising:

a polarizer; and

a pair of protective films between which the polarizer is sandwiched,

wherein at least one of the protective films is the cellulose acylate film as described in [1].

[15] A polarizing plate comprising:

a polarizer; and

a pair of protective films between which the polarizer is sandwiched,

wherein at least one of the protective films is the cellulose acylate film as described in [3].

[16] A liquid crystal display device comprising:

a liquid crystal cell; and

two polarizing plates disposed on both sides of the liquid crystal cell,

wherein at least one of the polarizing plates is the polarizing plate as described in [14].

[17] A liquid crystal display device comprising:

a liquid crystal cell; and

two polarizing plates disposed on both sides of the liquid crystal cell,

wherein at least one of the polarizing plates is the polarizing plate as described in [15].

[18] The liquid crystal display device as described in [16], which is an IPS-mode liquid crystal display device.

[19] The liquid crystal display device as described in [17], which is an IPS-mode liquid crystal display device.

### BRIEF DESCRIPTION OF THE DRAWING

FIGS. 1A and 1B are explanatory views showing two construction examples where the polarizing plate of the present invention is combined with a functional optical film; and

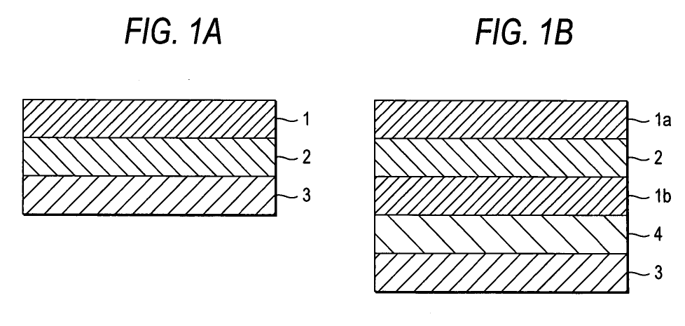

FIG. 2 is an explanatory view showing one example of the liquid crystal display device where the polarizing plate of the present invention is used,

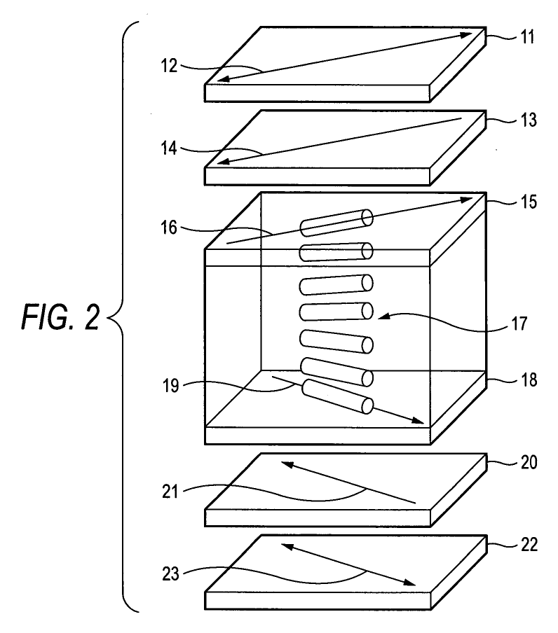

wherein 1, 1a and 1b denote Protective film, 2 denotes Polarizer, 3 denotes Functional optical film, 4 denotes Adhesive layer, 11 denotes Upper polarizing plate, 12 denotes Absorption axis of upper polarizing plate, 13 denotes Upper optically anisotropic layer, 14 denotes Orientation control direction of upper optically anisotropic layer, 15 denotes Upper substrate of liquid cell, 16 denotes Orientation control direction of upper substrate, 17 denotes Liquid crystal molecule, 18 denotes Lower substrate of liquid cell, 19 denotes Orientation control direction of lower substrate, 20 denotes Lower optically anisotropic layer, 21 denotes Orientation control direction of lower optically anisotropic layer, 22 denotes Lower polarizing plate, and 23 denotes Absorption axis of lower polarizing plate.

### DETAILED DESCRIPTION OF THE INVENTION

<Cellulose Acylate Film>

The cellulose acylate film of the present invention is a cellulose acylate film comprising a polymer of an ethylenically unsaturated monomer or comprising a poly-condensate composed of an organic acid and a glycol, wherein the low-molecular ester compound contained in the film, comprising the ethylenically unsaturated monomer or raw materials of the condensation polymer (the low molecular ester compound is composed of 5 or less raw material molecules) accounts for 1 mass % or less per the cellulose acylate film.

The polymer of an ethylenically unsaturated monomer and the condensation polymer composed of an organic acid and a glycol, for use in the present invention, are described below.

[Polymer of Ethylenically Unsaturated Monomer]

The polymer preferably has a mass average molecular weight of 500 to 10,000, and this polymer is considered to be located between an oligomer and a low molecular weight polymer. When the mass average molecular weight is 10,000 or less, good compatibility with the cellulose ester is obtained and bleed-out can be prevented from occurring. The mass average molecular weight is more preferably from 800 to 8,000, still more preferably from 1,000 to 5,000. The molecular weight distribution of the polymer of the invention can be measured and evaluated by gal permeation chromatography.

[Ethylenically Unsaturated Monomer]

Examples of the ethylenically unsaturated monomer which leads to the polymerization unit constituting the polymer for use in the present invention are set forth below, but the present invention is not limited thereto.

Examples of the ethylenically unsaturated monomer which can be used in the present invention include a vinyl ester such as vinyl acetate, vinyl propionate, vinyl butyrate, vinyl valerate, vinyl pivalate, vinyl caproate, vinyl caprate, vinyl laurate, vinyl myristate, vinyl palmitate, vinyl stearate, vinyl cyclohexanecarboxylate, vinyl octylate, vinyl methacrylate, vinyl crotonate, vinyl sorbate, vinyl benzoate and vinyl cinnamate; an acrylic acid ester and a methacrylic acid ester {hereinafter sometimes referred to as a (meth)acrylic acid ester}, such as methyl (meth)acrylate, ethyl (meth)acrylate, propyl (i- or n-) (meth)acrylate, butyl (n-, i-, s- or t-) (meth)acrylate, pentyl (n-, i- or s-) (meth)acrylate, hexyl (n- or i-) (meth)acrylate, heptyl (n- or i-) (meth)acrylate, octyl (n- or i-) (meth)acrylate, nonyl (n- or i-) (meth)acrylate, myristyl (n- or i-) (meth)acrylate, cyclohexyl (meth)acrylate, (2-ethylhexyl) (meth)acrylate, ε-caprolactone) (meth)acrylate, (4-methylcyclohexyl) (meth)acrylate, (4-ethylcyclohexyl) (meth)acrylate, (2-methoxyethyl) (meth)acrylate, (2-ethoxyethyl) (meth)acrylate, (2-hydroxyethyl) (meth)acrylate, (2-hydroxypropyl) (meth)acrylate, (3-hydroxypropyl) (meth)acrylate, (4-hydroxybutyl) (meth)acrylate, and (2-hydroxybutyl) (meth)acrylate; an aromatic monomer such as styrene, α-methylstyrene, vinyltoluene, 4-[(2-butoxyethoxy)methyl]styrene, 4-butoxymethoxystyrene, 4-butylstyrene, 4-decylstyrene, 4-(2-ethoxymethyl)styrene, 4-(1-ethylhexyloxymethyl)styrene, 4-hydroxymethylstyrene, 4-octyloxymethylstyrene, 4-octylstyrene, 4-propoxymethylstyrene, phenyl (meth)acrylate, (2- or 4-chlorophenyl) (meth)acrylate, (2-, 3- or 4-ethoxycarbonylphenyl) (meth)acrylate, (o-, m- or p-tolyl) (meth)acrylate, benzyl (meth)acrylate, phenethyl (meth)acrylate, (2-naphthyl) (meth)acrylate, and p-hydroxymethylphenyl (meth)acrylate; and an unsaturated acid, such as acrylic acid, methacrylic acid, maleic anhydride, crotonic acid and itaconic acid.

The polymer constituted by the monomer above may be either a copolymer or a homopolymer, and a homopolymer of vinyl ester, a copolymer of vinyl ester, a copolymer of vinyl ester and (meth)acrylic acid ester, and a homopolymer or copolymer of (meth)acrylic acid ester are preferred. Among these polymers, more preferred are a copolymer of vinyl ester and (meth)acrylic acid ester, and a homopolymer or copolymer of (meth)acrylic acid ester, which are an acrylic polymer.

In the present invention, an acrylic polymer where the content of a polymerization unit based on a (meth)acrylic acid ester having an aromatic ring or a cyclohexyl group in its side chain is not more than a subsidiary amount may be used.

In the case where the acrylic polymer contains a polymerization unit based on a (meth)acrylic acid ester having an aromatic ring or a cyclohexyl group in its side chain, the polymer preferably contains from 20 to 40 mass % of a polymerization unit based on a (meth)acrylic acid ester having an aromatic ring or a cyclohexyl group in its side chain and from 50 to 80 mass % of a polymerization unit based on a (meth)acrylic acid ester having neither an aromatic ring nor a cyclohexyl group. The polymer may also contain from 2 to 20 mass % of a polymerization unit based on a (meth)acrylic acid ester having a hydroxyl group, which is described later.

Out of those (meth)acrylic acid ester monomers, examples of the (meth)acrylic acid ester monomer having neither an aromatic ring nor a cyclohexyl group include methyl (meth)acrylate, ethyl (meth)acrylate, propyl (i- or n-) (meth)acrylate, butyl (n-, i-, s- or t-) (meth)acrylate, pentyl (n-, i- or s-) (meth)acrylate, hexyl (n- or i-) (meth)acrylate, heptyl (n- or i-) (meth)acrylate, octyl (n- or i-) (meth)acrylate, nonyl (n- or i-) (meth)acrylate, myristyl (n- or i-) (meth)acrylate, (2-ethylhexyl) (meth)acrylate, (ε-caprolactone) (meth)acrylate, (2-hydroxyethyl) (meth)acrylate, (2-hydroxypropyl) (meth)acrylate, (3-hydroxypropyl) (meth)acrylate, (4-hydroxybutyl) (meth)acrylate, (2-hydroxybutyl) (meth)acrylate, (2-methoxyethyl) (meth)acrylate, and (2-ethoxyethyl) (meth)acrylate.

The acrylic polymer particularly preferred in the present invention is a homopolymer or copolymer of the monomer above, and the polymer is more preferably a polymer containing 30 mass % or more of a methyl acrylate monomer unit or a polymer containing 40 mass % or more of a methyl methacrylate monomer unit, still more preferably a homopolymer of methyl acrylate or methyl methacrylate.

In the acrylic polymer, a polymerization unit based on a (meth)acrylic acid ester monomer having a hydroxyl group can be preferably used. The monomer having a hydroxyl group is the same as the monomer described above but is preferably a (meth)acrylic acid ester such as (2-hydroxyethyl) (meth)acrylate, (2-hydroxypropyl) (meth)acrylate, (3-hydroxypropyl) (meth)acrylate, (4-hydroxybutyl) (meth)acrylate, (2-hydroxybutyl (meth)acrylate, p-hydroxymethylphenyl (meth)acrylate and p-(2-hydroxy-ethyl)phenyl (meth)acrylate. Among these, 2-hydroxyethyl acrylate and 2-hydroxyethyl methacrylate are more preferred. The amount of the polymerization unit based on a (meth)acrylic acid ester monomer having a hydroxyl group, which is contained in the polymer, is preferably from 2 to 20 mass %, more preferably from 2 to 10 mass %, based on the polymer.

As for the ethylenically unsaturated monomer having a functional group useful for the polymer of the present invention, those having an ultraviolet-absorbing group or an antistatic group in the polymer side chain may also be used. As long as Tg of the copolymer obtained becomes 50° C. or less, any group may be used without limitation. The ethylenic group of the ethylenically unsaturated monomer having a functional group is a vinyl group, an acryloyl group or a methacryloyl group, and these groups may be preferably used.

Examples of the ultraviolet-absorbing group of the ethylenically unsaturated monomer having an ultraviolet-absorbing group useful for the present invention include a benzotriazole group, a salicylic acid ester group, a benzophenone group, an oxybenzophenone group and a cyanoacrylate group, and these groups all may be preferably used in the present invention.

As for the ethylenically unsaturated monomer having an ultraviolet-absorbing group, the ultraviolet-absorbing monomer constituting an ultraviolet-absorbing polymer described in JP-A-6-148430 and the ultraviolet-absorbing monomer described in JP-A-2002-20410 may be preferably used.

Examples of the antistatic group of the ethylenically unsaturated monomer having an antistatic group include a quaternary ammonium group, a sulfonate group and a polyethylene oxide group. In view of solubility and electric charging performance, a quaternary ammonium group is preferred. The ethylenically unsaturated monomer having an antistatic group described in JP-A-2002-20410 may be preferably used.

The stable performance of a polarizing plate under high-temperature high-humidity conditions is recently more and more becoming important. The present inventors have made intensive studies to more enhance the stable performance of a polarizing plate under high-temperature high-humidity conditions, as a result, it has been found that when a cellulose acylate film containing a polymer of an ethylenically unsaturated monomer is used as a polarizing plate protective film, reduction in the content of the ethylenically unsaturated monomer contained in the film, that is, the residual unreacted monomer carried over with the polymer and contained in the film, is effective.

The iodine monomer contained in the polarizer of a polarizing plate is known to interact with an electron-donating compound such as triethylamine (see, for example, J. Am. Chem. Soc., Vol. 80, page 520 (1958)). The ethylenically unsaturated monomer is also an electron-donating compound and therefore, when such a compound is contained in the polarizing plate protective film, the compound interacts with the iodine molecule in the polarizer and this is considered to cause deterioration of the polarizer.

The amount of the ethylenically unsaturated monomer contained in the cellulose acylate film of the present invention needs to be from 0 to 1 mass % and is preferably from 0 to 0.7 mass %, more preferably from 0 to 0.6 mass %, and most preferably 0 to 0.2 mass %.

The amount of the residual monomer in the polymer can adjusted and reduced by a known method such as selecting the kind of the solvent at the precipitation after the completion of polymerization or increasing the number of precipitations. Also, the monomer may be vaporized or dissipated by heat-treating the polymer after the completion of polymerization.

The residual monomer amount in the film can be easily determined by gas chromatography.

[Specific Examples of Polymer for Use in the Present Invention]

Specific examples of the polymer for use in the present invention are set forth below, but the present invention is not limited thereto.

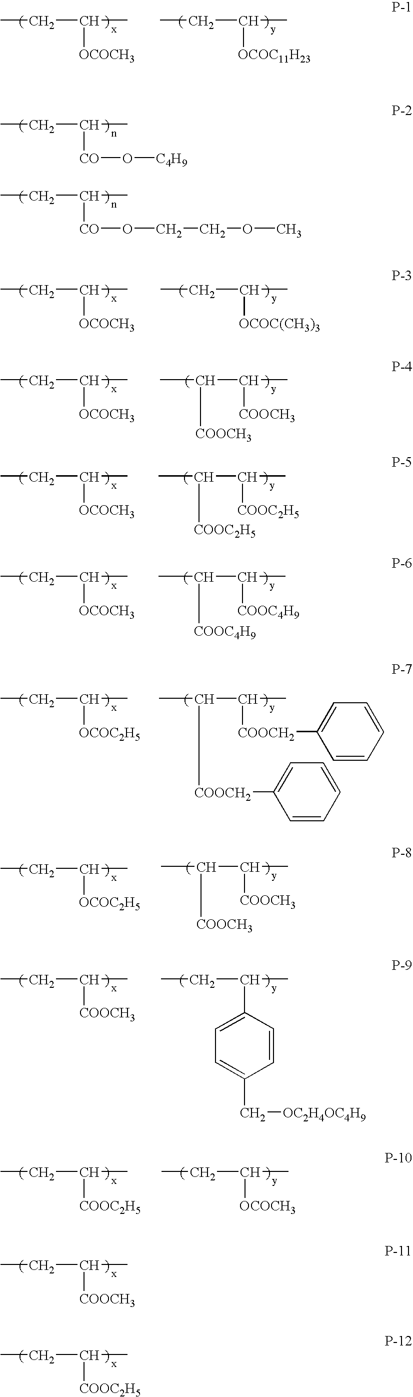

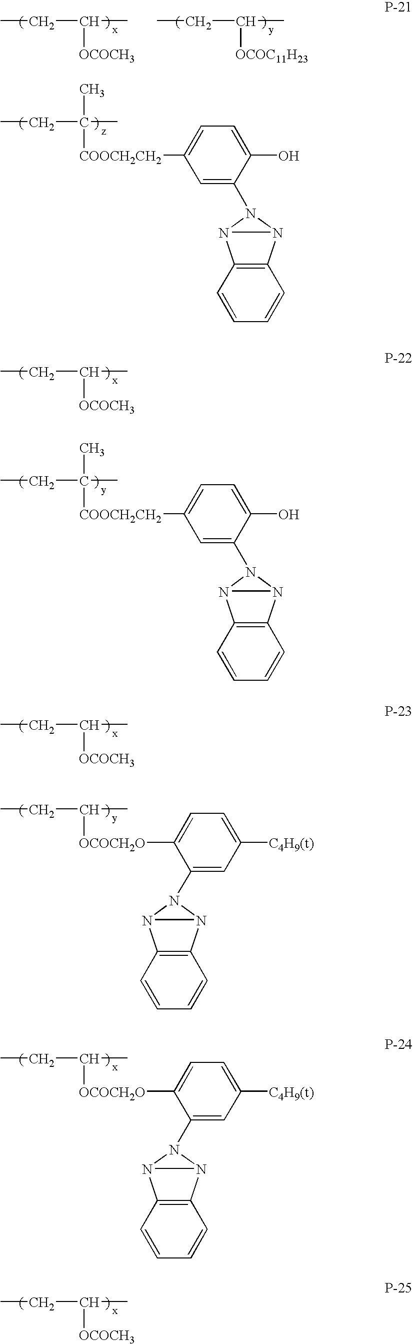

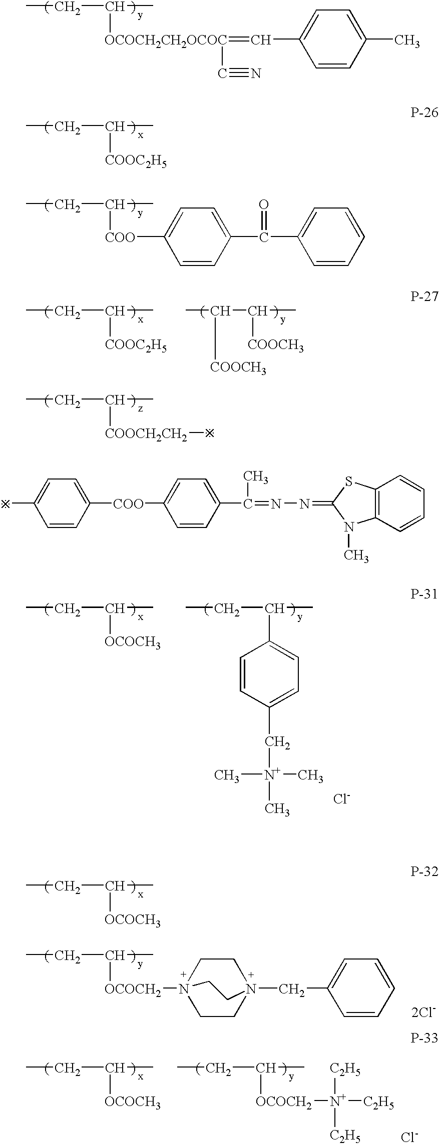

The amount added of the polymer for use in the present invention is preferably from 0.01 to 30 mass %, more preferably from 1 to 25 mass %, still more preferably from 5 to 20 mass %, based on the cellulose acylate.

As for the polymer used in the present invention, one polymer may be used alone, or two or more compounds may be mixed and used at an arbitrary ratio.

In the present invention, the polymer may be added at any timing during the process of producing a dope or may be added at the end of the dope preparation step.

The method for synthesizing the polymer for use in the present invention includes a method using a peroxide polymerization initiator such as cumene peroxide and tert-butyl hydroperoxide; a method using a polymerization initiator in a larger amount than usual; a method using a chain transfer agent such as mercapto compound and carbon tetrachloride in addition to a polymerization initiator; a method using a polymerization terminator such as benzoquinone and dinitrobenzene in addition to a polymerization initiator; the method described in JP-A-2000-128911 or JP-A-2000-344823 in which bulk polymerization is performed using a polymerization catalyst comprising a compound having one thiol group and a secondary hydroxyl group or comprising the compound above and an organic metal compound in combination; and the synthesis methods described in JP-A-2002-20410 and JP-A-2003-12859. Any of these methods can be preferably used in the present invention.

The content of the ethylenically unsaturated monomer in the polymer can be adjusted by crystallization or reduced-pressure distillation of the polymer or by repeating such an operation.

[Condensation polymer of Organic Acid and Glycol]

The condensation polymer of an organic acid and a glycol for use in the present invention preferably has a mass average molecular weight of 500 to 10,000 and is a condensation polymer considered to be situated between an oligomer and a low molecular weight polymer. When the mass average molecular weight is 10,000 or less, good compatibility with a cellulose ester is ensured and generation of bleed-out can be suppressed. The mass average molecular weight is more preferably from 800 to 5,000, still more preferably from 1,000 to 3,000. The molecular weight distribution of the polymer of the invention can be measured and evaluated by gal permeation chromatography.

The organic acid forming the basic skeleton of the condensation polymer of the present invention is preferably a dibasic acid.

The dibasic acid is preferably an aliphatic dibasic acid, an alicyclic dibasic acid or an aromatic dibasic acid. Examples of the aliphatic dibasic acid include malonic acid, succinic acid, glutaric acid, adipic acid, pimelic acid, suberic acid, azelaic acid, sebacic acid, undecanedicarboxylic acid and dodecanedicarboxylic acid; examples of the aromatic dibasic acid include phthalic acid, terephthalic acid, isophthalic acid and 1,4-xylidene dicarboxylic acid; and examples of the alicyclic dibasic acid include 1,3-cyclobutanedicarboxylic acid, 1,3-cyclopentanedicarboxylic acid, 1,4-cyclohexanedicarboxylic acid and 1,4-cyclohexanediacetic acid. In particular, an aliphatic dicarboxylic acid having a carbon number of 4 to 12, an alicyclic dibasic acid and an aromatic dicarboxylic acid are preferred. Two or more kinds of dibasic acids selected from these may be used in combination.

Examples of the glycol include ethylene glycol, diethylene glycol, 1,2-propylene glycol, 1,3-propylene glycol, 2-methyl-1,3-propanediol, 1,2-butylene glycol, 1,3-butylene glycol, 1,4-butylene glycol, 1,5-pentanediol, 3-methyl-1,5-pentanediol, 1,6-hexanediol, 1,4-cyclohexanediol, 1,5-pentylene glycol, 1,4-cyclohexanedimethanol, neopentyl glycol, diethylene glycol, triethylene glycol and tetraethylene glycol. Among these, preferred are ethylene glycol, 1,2-propylene glycol, 1,3-propylene glycol, 1,2-butylene glycol, 1,3-butylene glycol, 1,4-butylene glycol, 1,6-hexanediol, 1,4-cyclohexanedimethanol and diethylene glycol, triethylene glycol, more preferred are 1,3-propylene glycol, 1,4-butylene glycol, 1,6-hexanediol and diethylene glycol. These glycols each may be used alone, or two or more kinds thereof may be mixed and used.

Also, the terminal of the condensation polymer may be blocked with a monohydric alcohol having a carbon number of 2 to 20 or a monovalent carboxylic acid having a carbon number of 2 to 20.

The condensation polymer for use in the present invention is preferably a compound represented by the following formula (I) or (II):

Formula (I):
R-(A-G)ₘ-A-R
Formula (II):
S-(G-A)ₘ-G-S

In formulae (I) and (I), A is a dibasic acid residue having an average carbon number of 2 to 10, G is a glycol residue having an average carbon number of 2 to 6, R is a monohydric alcohol residue having an average carbon number of 2 to 20, S is a monovalent carboxylic acid residue having an average carbon number of 2 to 20, and m is an integer of 1 or more.

The dibasic acid is preferably succinic acid, adipic acid, sebacic acid, phthalic acid, terephthalic acid or 1,4-cyclohexyldicarboxylic acid, more preferably succinic acid, adipic acid or phthalic acid.

Specific examples of the copolymer of a dibasic acid and a glycol include, but are not limited to, the followings:

the polyester polyols described in JP-A-2006-64803, such as Polyester Polyol PEO-1 (a polyester polyol comprising succinic acid and 1,4-butylene glycol, average carbon number of glycol: 3.3, carbon number of dibasic acid: 4) and PEO-2 (a polyester polyol comprising adipic acid, 1,4-butylene glycol and ethylene glycol, average carbon number of glycol: 3.3, carbon number of dibasic acid: 6); and the polyesters described in JP-A-2006-342227, such as PE-1 (a polyester comprising succinic acid and ethylene glycol, in which the terminal is blocked (stopped) with 2-ethylhexyl group), PE-2 (a polyester comprising adipic acid, 1,4-butylene glycol and ethylene glycol, average carbon number of glycol: 3.33, carbon number of dibasic acid: 6), PE-3 (a polyester comprising adipic acid, succinic acid and ethylene glycol, average carbon number of glycol: 2, carbon number of dibasic acid: 4.5), Polycizer W-2640S, Polycizer W-305ELS, Polycizer P-103, Polylite OD-X-286, Polylite OD-X-2251, Polylite OD-X-2802 (produced by Dainippon Ink and Chemicals, Inc.), ADK CIZER PN150, ADK CIZER PN170, ADK CIZER PN7120, ADK CIZER PN110, ADK CIZER PN1430, ADK CIZER PN77 (produced by Asahi Denka Co., Ltd.), D643, D633, D620, D671 (produced by J-PLUS Co., Ltd.), and COSMOL 102 (produced by The Nisshin OilliO Group, Ltd.).

The low molecular ester compound comprising raw materials of the condensation polymer for use in the present invention is composed of raw materials, that is, a dibasic acid, a glycol and a monohydric alcohol or monovalent carboxylic acid. The low molecular ester is a composed of 5 or less molecules which are selected from the organic acid, the glycol and the monohydric alcohol which are the raw materials. The compound composed of 6 or more molecules has little effect to an aging property of the polarizing plate including the cellulose acylate film including the condensation polymer. It is preferable that the contained amount of the low molecular ester composed of 5 or less molecules is small. It is more preferable that the contained amount of the low molecular ester composed of 3 or less molecules is small.

Specific examples thereof include bis(2-ethylhexyl) adipate, dinonyl adipate, bis(4-hydroxybutyl) adipate, bis(2-hydroxybutyl) succinate and bis(5-hydroxy-3-methylpentyl) phthalate. The content of the low molecular ester can be adjusted by crystallization or reduced-pressure distillation of the condensation polymer or by repeating such an operation.

The condensation polymer of the present invention is synthesized by an ordinary method. For example, the condensation polymer can be easily synthesized by any one of a direct reaction of the dibasic acid and the glycol, a heat-melting condensation method utilizing a polyesterification or transesterification reaction of the dibasic acid or alkyl esters thereof, such as methyl ester of dibasic acid, with glycols, and a dehydrohalogenation reaction of an acid chloride of such an acid with a glycol, but a polyester of which mass average molecular weight is not so large is preferably synthesized by the direction reaction. The method for adjusting the molecular weight is not particularly limited and may be adjusted using a conventional method. For example, the molecular weight can be adjusted by blocking the molecular terminal with a monovalent acid or monohydric alcohol and controlling the amount added thereof, though this may vary depending on the polymerization conditions.

The amount of the low molecular ester in the film can be easily determined by gas chromatography.

The amount added of the condensation polymer for use in the present invention is preferably from 0.01 to 30 mass %, more preferably from 1 to 25 mass %, still more preferably from 5 to 20 mass %, based on the cellulose acylate.

As for the condensation polymer of the present invention, one compound may be used alone, or two or more kinds of compounds may be mixed at an arbitrary ratio and used.

The condensation polymer for use in the present invention may be added at any time during the process of producing a dope or may be added at the final of the dope preparation step.

The cellulose acylate film of the present invention preferably contains a polymer of an ethylenically unsaturated monomer, because the retardation can be reduced.

In the condensation polymer for use in the present invention, which is composed of a polymer of an ethylenically unsaturated monomer or composed of an organic acid and a glycol, Rth(630) preferably satisfies the following formula (3).
|Rth(a)−Rth(0)|/a≧1.0 Formula (3):

Rth(a): Rth (nm) at a wavelength of 630 nm of the cellulose acylate film containing a % of a retardation adjusting agent,

Rth(0): Rth (nm) at a wavelength of 630 nm of the cellulose acylate film not containing a retardation adjusting agent, and

a: the parts by mass of the retardation adjusting agent per 100 parts by mass of cellulose acylate and the value thereof is in the range of 0.01≦a≦30.

Furthermore, the polymer for use in the present invention more preferably satisfies the following formula (3-1), still more preferably formula (3-2):
(Rth(a)−Rth(0))/a≦−1.5 Formula (3-1):
(Rth(a)−Rth(0))/a≦−2.0 Formula (3-2):

Rth(a), Rth(0), a and the range of a are the same as defined above in formula (3).

(Ultraviolet Absorbent)

The cellulose acylate film of the present invention preferably contains an ultraviolet absorbent.

An arbitrary kind of ultraviolet absorbent may be selected according to the purpose and, for example, an absorbent such as salicylic acid ester type, benzophenone type, benzotriazole type, triazine type, benzoate type, cyanoacrylate type and nickel complex salt type can be used. Among these, preferred are benzophenone type, benzotriazole type and triazine type.

In view of dissipation by volatilization, the ultraviolet absorbent for use in the present invention preferably has a molecular weight of 250 to 1,000, more preferably from 260 to 800, still more preferably from 270 to 800, yet still more preferably from 300 to 800. As long as the molecular weight is in this range, the compound may have a specific monomer structure or may have a multimer, oligomer or polymer structure in which a plurality of monomer units are connected.

Examples of the benzophenone-based ultraviolet absorbent include 2,4-dihydroxybenzophenone, 2-hydroxy-4-acetoxybenzophenone, 2-hydroxy-4-methoxybenzophenone, 2,2′-dihydroxy-4-methoxybenzophenone, 2,2′-dihydroxy-4,4′-methoxybenzophenone, 2-hydroxy-4-n-octoxybenzophenone, 2-hydroxy-4-dodecyloxybenzophenone and 2-hydroxy-4-(2-hydroxy-3-methacryloxy)propoxybenzophenone.

Examples of the benzotriazole-based ultraviolet absorbent include 2-(2′-hydroxy-3′-tert-butyl-5′-methylphenyl)-5-chlorobenzotriazole, 2-(2′-hydroxy-5′-tert-butylphenyl)benzotriazole, 2-(2′-hydroxy-3′,5′-di-tert-amylphenyl)benzotriazole, 2-(2′-hydroxy-3′,5′-di-tert-butylphenyl)-5-chlorobenzotriazole and 2-(2′-hydroxy-5′-tert-octylphenyl)benzotriazole.

Examples of the triazine-based ultraviolet absorbent include the compounds described in JP-A-10-182621 and the compounds (UVT-1 to UVT-4) shown below.

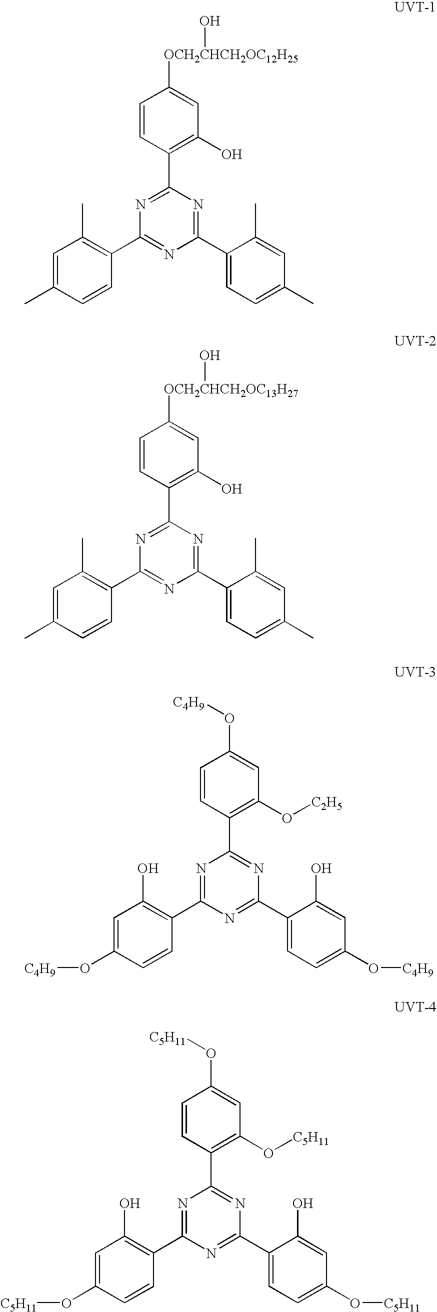

The ultraviolet absorbent for use in the present invention is preferably in a liquid state at 25° C. The ultraviolet absorbent in a liquid state is a so-called room-temperature liquid ultraviolet absorbent under 1 atmosphere. Here, the term “room-temperature liquid” indicates that at 25° C., as defined in Encyclopaedia Chimica, Kyoritsu Shuppan (1963), the substance has no definite shape, has fluidity and has a nearly constant volume. Accordingly, as long as the substance has these properties, the melting point is not limited, but a compound having a melting point of 30° C. or less, particularly 15° C. or less, is preferred.

For example, in the case of using a liquid UV agent (UVT-23L, UVT-28L), as compared with the powder “Tinuvin 326 (TN326)”, even when a residual monomer derived from a polymer is present, the transmittance change as the durability of a polarizing plate can be reduced.

The liquid ultraviolet absorbent may be a single compound or a mixture. As for the mixture, a mixture comprising a group of structural isomers can be preferably used.

The liquid ultraviolet absorbent may take any structure as long as the above-described conditions are satisfied, but in view of light fastness of the ultraviolet absorbent itself, a 2-(2′-hydroxyphenyl)benzotriazole-based compound represented by the following formula (1) is preferred.
Formula (1):

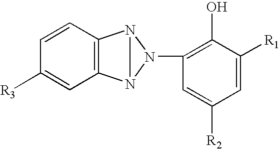

In formula (1), R₁, R₂ and R₃ each represents a hydrogen atom, a halogen atom, an alkyl group, an aryl group, an alkoxy group, an aryloxy group, an alkenyl group, a nitro group or a hydroxyl group.

Examples of the halogen atom include a fluorine atom, a chlorine atom and a bromine atom, with a chlorine atom being preferred.

The alkyl group and alkoxy group are preferably an alkyl group and alkoxy group each having a carbon number of 1 to 30, and the alkenyl group is preferably an alkenyl group having a carbon number of 2 to 30. These groups each may be linear or branched. The alkyl group, alkoxy group and alkenyl group each may further has a substituent. Specific examples of the alkyl group, alkoxy group and alkenyl group include a methyl group, an ethyl group, an isopropyl group, a tert-butyl group, a sec-butyl group, an n-butyl group, an n-amyl group, a sec-amyl group, a tert-amyl group, an octyl group, a nonyl group, a dodecyl group, an eicosyl group, an α,α-dimethylbenzyl group, an octyloxycarbonylethyl group, a methoxy group, an ethoxy group, an octyloxy group and an allyl group.

The aryloxy group and aryl group are preferably, for example, a phenyl group and a phenyloxy group and each may have a substituent. Specific examples thereof include a phenyl group, a 4-tert-butylphenyl group and a 2,4-di-tert-amylphenyl group.

Among the groups represented by R₁ and R₂, a hydrogen atom, an alkyl group, an alkoxy group and an aryl group are preferred, and a hydrogen atom, an alkyl group and an alkoxy group are more preferred.

Among the groups represented by R₃, a hydrogen atom, a halogen atom, an alkyl group and an alkoxy group are preferred, and a hydrogen atom, an alkyl group and an alkoxy group are more preferred.

For allowing the compound to become liquid at room temperature, a compound where out of the groups represented by R₁, R₂ and R₃, at least one group is an alkyl group is preferred, and a compound where at least two groups are an alkyl group is more preferred.

The alkyl group may take any form but at least one alkyl group is preferably a tertiary alkyl group or a secondary alkyl group. In particular, it is preferred that at least one alkyl group represented by R₁ and R₂ is a tertiary alkyl group or a secondary alkyl group.

Specific representative examples of the liquid ultraviolet absorbent preferably used in the present invention are shown below.

TABLE 1

| Compound No. | R₁ | R₂ | R₃ |
|---|---|---|---|
| UV-1L | —CH₃ | —C₄H₉(s) | —H |
| UV-2L | —C₄H₉(s) | —C₄H₉(t) | —C₄H₉(t) |
| UV-3L | —C₄H₉(s) | —C₄H₉(t) | —C₄H₉(n) |
| UV-4L | —C₄H₉(s) | —C₄H₉(t) | —C₅H₁₁(t) |
| UV-5L | —C₄H₉(s) | —C₄H₉(t) | —C₅H₁₁(n) |
| UV-6L | —C₄H₉(s) | —C₅H₁₁(t) | —C₄H₉(t) |
| UV-7L | —C₄H₉(s) | —C₅H₁₁(t) | —C₄H₉(n) |
| UV-8L | —C₄H₉(t) | —C₄H₉(t) | —C₄H₉(s) |
| UV-9L | —C₅H₁₁(t) | —C₅H₁₁(t) | —C₄H₉(s) |
| UV-10L | —C₄H₉(t) | —C₅H₁₁(t) | —C₄H₉(s) |
| UV-11L | —C₄H₉(s) | —C₄H₉(s) | —Cl |
| UV-12L | —C₄H₉(s) | —C₄H₉(s) | —OCH₃ |
| UV-13L | —C₄H₉(s) | —C₄H₉(s) | —C₄H₉(t) |
| UV-14L | —C₄H₉(s) | —C₄H₉(s) | —C₄H₉(n) |
| UV-15L | —C₄H₉(t) | —C₂H₄COOC₈H₁₇ | —H |
| UV-16L | —C₄H₉(t) | —C₂H₄COOC₈H₁₇ | —Cl |
| UV-17L | —C₄H₉(t) | 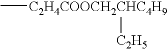 | —H |
| UV-18L | —C₄H₉(t) | 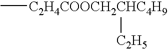 | —Cl |
| UV-19L | —C₄H₉(t) | —C₂H₄COOC₂H₄OC₄H₉ | —H |
| UV-20L | —C₄H₉(t) | —C₂H₄COOC₂H₄OC₄H₉ | —Cl |
| UV-21L | —C₈H₁₇ | —CH₃ | —H |
| UV-22L | —C₁₀H₂₁ | —CH₃ | —H |
| UV-23L | —C₁₂H₂₅ | —CH₃ | —H |
| UV-24L | —C₁₆H₃₃ | —CH₃ | —H |
| UV-25L | —C₂₀H₄₁ | —CH₃ | —H |
| UV-26L | —C₂₂H₄₅ | —CH₃ | —H |
| UV-27L | —C₂₄H₄₉ | —CH₃ | —H |
| UV-28L | —C₄H₉(t) | —Cl | —Cl |

As for the ultraviolet absorbent, a plurality of absorbents differing in the absorption wavelength are preferably used in combination, because a high shielding effect can be obtained over a wide wavelength range. The ultraviolet absorbent for liquid crystal preferably has excellent capability of absorbing ultraviolet light at a wavelength of 370 nm or less from the standpoint of preventing deterioration of liquid crystal, and preferably less absorbs visible light at a wavelength 400 nm or more in view of liquid crystal display property.

Also, as for the ultraviolet absorbent, the compounds described in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509 and JP-A-2000-204173 can be used.

The amount of the ultraviolet absorbent added is preferably from 0.001 to 5 mass %, more preferably from 0.01 to 1 mass %, based on the cellulose acylate. When the amount added is 0.001 mass % or more, the effect by the addition can be satisfactorily brought out and this is preferred, whereas when the amount added is 5 mass % or less, the ultraviolet absorbent can be advantageously prevented from bleeding out to the film surface,

The ultraviolet absorbent may be added simultaneously at the time of dissolving the cellulose acylate or may be added to the dope after the dissolution. The ultraviolet absorbent is preferably added to the dope after the dissolution, and in that case, a mode of adding the ultraviolet absorbent solution to the dope immediately before casting by using a static mixer or the like is particularly preferred, because the spectral absorption properties can be easily adjusted.

[Retardation of Cellulose Acylate Film]

The retardations Re and Rth are described in detail below.

In the present invention, Re(λ) and Rth(λ) indicate the in-plane retardation and the retardation in a thickness-direction, respectively, at a wavelength of λ.

[Measurement of Retardation Value]

The method for measuring the retardation of the cellulose acylate film of the present invention is described below.

(In-Plane Retardation Re and Retardation Rth in Thickness Direction)

In the present invention, Re(λ) and Rth(λ) indicate the in-plane retardation and the retardation in a thickness-direction, respectively, at a wavelength of λ. Re(λ) is measured by making light at a wavelength of λ nm to be incident in the film normal direction in “KOBRA 21ADH” or “KOBRA WR” {manufactured by Oji Scientific Instruments}.

In the case where the film measured is a film represented by a uniaxial or biaxial refractive index ellipsoid, the Rth(λ) is calculated by the following method.

The retardation value is measured at 6 points in total by making light at a wavelength of λ nm to be incident from directions inclined with respect to the film normal direction in 10° steps up to 50° on one side from the normal direction while using the in-plane slow axis (judged by “KOBRA 21ADH” or “KOBRA WR”) as the inclination axis (rotation axis) (when the slow axis is not present, an arbitrary direction in the film plane is used as the rotation axis), and Rth(λ) is calculated by “KOBRA 21ADH” or “KOBRA WR” based on the retardation values measured, the assumed values of average refractive index and the film thickness values input.

In the above, when the film has a direction where the retardation value becomes zero at a certain inclination angle from the normal direction with the rotation axis being the in-plane slow axis, the retardation value at an inclination angle larger than that inclination angle is calculated by “KOBRA 21ADH” or “KOBRA WR” after converting its sign into a negative sign.

Incidentally, after measuring the retardation value from two arbitrary inclined directions by using the slow axis as the inclination axis (rotation axis) (when the slow axis is not present, an arbitrary direction in the film plane is used as the rotation axis), based on the values obtained, the assumed values of average refractive index and the film thickness values input, Rth can also be calculated according to the following formulae (4) and (5).

$$Formula ( 4 )$$

$$Re ( θ ) = [ nx - \frac{ny \times nz}{\sqrt{{\{ n y sin ( {sin}^{- 1} ( \frac{sin ( - θ )}{nx} ) ) \}}^{2} + {\{ n z cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}}$$

Re(θ) represents a retardation value in the direction inclined at an angle of θ from the normal direction. In formula (4), nx represents the refractive index in the in-plane slow axis direction, ny represents the refractive index in the direction crossing with nx at right angles in the plane, and nz represents the refractive index crossing with nx and ny at right angles.

$$Rth = [ \frac{nx + ny}{2} - nz ] \times d \qquad Formula ( 5 )$$

In the case where the film measured is a film incapable of being represented by a uniaxial or biaxial refractive index ellipsoid or a film having no so-called optic axis, Rth(λ) is calculated by the following method.

The retardation value is measured at 11 points by making light at a wavelength of λ nm to be incident from directions inclined with respect the film normal direction in 10° steps from −50° to +50° while using the in-plane slow axis (judged by “KOBRA 21ADH” or “KOBRA WR”) as the inclination axis (rotation axis), and Rth(λ) is calculated by “KOBRA 21ADH” or “KOBRA WR” based on the retardation values measured, the assumed values of average refractive index and the film thickness values input.

In the measurement above, as for the assumed value of average refractive index, the values described in Polymer Handbook (John Wiley & Sons, Inc.) and catalogues of various optical films can be used. The average refractive index of which value is unknown can be measured by an Abbe refractometer.

The values of average refractive index of main optical films are as follows: cellulose acylate (1.48), cycloolefin polymer (1.52), polycarbonate (1.59), polymethyl methacrylate (1.49) and polystyrene (1.59). When such an assumed value of average refractive index and the film thickness are input, “KOBRA 21ADH” or “KOBRA WR” calculates nx, ny and nz and from these calculated nx, ny and nz, Nz=(nx−nz)/(nx−ny) is further calculated.

In the present invention, as for the cellulose acylate film having small optical anisotropy (Re, Rth), the in-plane retardation Re and the retardation Rth in the thickness direction at a wavelength of 630 nm preferably satisfy the ranges of the following formulae (1) and (2), respectively.
−25 nm≦Rth(630)≦25 nm Formula (1):
0 nm≦Re(630)≦10 nm Formula (2):

The retardations Rth and Re more preferably satisfy the ranges of the following formulae (1-1) and (2-1), still more preferably the ranges of the following formulae (1-2) and (2-2).
−20 nm≦Rth(630)≦20 nm Formula (1-1):
0 nm≦Re(630)≦5 nm Formula (2-1):
−15 n≦Rth(630)≦15 nm Formula (1-2):
0 nm≦Re(630)≦2 nm Formula (2-2):

The cellulose acylate film of the present invention preferably satisfies the condition that, in the wavelength range of 400 to 700 nm, the fluctuation of Rth is 25 nm or less and the fluctuation of Re is 10 nm or less, more preferably the condition that the fluctuation of Rth is 20 nm or less and the fluctuation of Re is 5 nm or less, still more preferably the condition that the fluctuation of Rth is 15 nm or less and the fluctuation of Re is 3 nm or less.

[Cellulose Acylate]

[Raw Material Cotton for Cellulose Acylate]

Examples of the cellulose as the raw material of cellulose acylate for use in the present invention include cotton linter and wood pulp (e.g., hardwood pulp, softwood pulp). A cellulose acylate obtained from any raw material cellulose may be used and depending on the case, a mixture of raw material celluloses may be used. These raw material celluloses are described in detail, for example, in Marusawa and Uda, Plastic Zairyo Koza (17), Seni-kei Jushi (Plastic Material Lecture (17), Fiber-Based Resin), Nikkan Kogyo Shinbun Sha (1970), and JIII Journal of Technical Disclosure, No. 2001-1745, pp. 7-8, and celluloses described therein can be used and are not particularly limited in the application to the cellulose acylate film of the present invention.

[Substitution Degree of Cellulose Acylate]

The cellulose acylate of the present invention produced using the above-described cellulose as the raw material is described below.

The cellulose acylate of the present invention is a cellulose of which hydroxyl group is acylated, and the substituent may be any acyl group from an acyl group (carbon number: 2) to an acetyl group (carbon number: 22). In the cellulose acylate of the present invention, the substitution degree to the hydroxyl group of cellulose is not particularly limited. The substitution degree can be determined by calculation after measuring the bonding degree of an acetic acid and/or a fatty acid having a carbon number of 3 to 22, substituted to the hydroxyl group of cellulose. As for the measuring method, the measurement may be performed according to ASTM D-817-91.

As described above, in the cellulose acylate of the present invention, the substitution degree to the hydroxyl group of cellulose is not particularly limited, but the acyl substitution degree to the hydroxyl group of cellulose is preferably from 2.50 to 3.00, more preferably from 2.75 to 3.00, still more preferably from 2.85 to 3.00.

Out of the acetic acid and/or fatty acid having a carbon number of 3 to 22 substituted to the hydroxyl group of cellulose, the acyl group having a carbon number of 2 to 22 is not particularly limited and may be an aliphatic group or an allyl group or may be a single acyl group or a mixture of two or more kinds of acyl groups. Examples thereof include an alkylcarbonyl ester of cellulose, an alkenylcarbonyl ester of cellulose, an aromatic carbonyl ester of cellulose, and an aromatic alkylcarbonyl ester of cellulose, and these esters each may further have a substituted group. Preferred examples of the acyl group therefor include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a tert-butanoyl group, a cyclohexanecarbonyl group, an oleoyl group, a benzoyl group, a naphthylcarbonyl group and a cinnamoyl group. Among these, preferred are acetyl, propionyl, butanoyl, dodecanoyl, octadecanoyl, tert-butanoyl, oleoyl, benzoyl, naphthylcarbonyl and cinnamoyl, more preferred are acetyl, propionyl and butanoyl, and most preferred is an acetyl group.

In the case where the acyl substituent substituted to the hydroxyl group of cellulose substantially comprises at least two kinds of acyl groups selected from an acetyl group, a propionyl group and a butanoyl group, when the entire substitution degree thereof is from 2.50 to 3.00, the optical anisotropy of the cellulose acylate film can be more suitably decreased. The acyl substitution degree is more preferably from 2.60 to 3.00, still more preferably from 2.65 to 3.00.

In the case where the acyl substituent of the cellulose acylate comprises only an acetyl group, when the entire substitution degree thereof is from 2.50 to 2.95, the optical anisotropy of the cellulose acylate film can be more suitably decreased.

[Polymerization Degree of Cellulose Acylate]

The polymerization degree of the cellulose acylate preferably used in the present invention is, in terms of the viscosity average polymerization degree, preferably from 180 to 700, more preferably from 180 to 550, still more preferably from 180 to 400, yet still more preferably from 180 to 350. When the polymerization degree is not more than the upper limit above, the viscosity of the dope solution of cellulose acylate does not become too high and the production of a film by casting is advantageously facilitated. When the polymerization degree is not less than the lower limit above, there arises no trouble such as decrease in the strength of the film produced, and this is preferred. The average polymerization degree can be measured according to the intrinsic viscosity method proposed by Uda, et al. (Kazuo Uda and Hideo Saito, Journal of the Society of Fiber Science and Technology, Japan, Vol. 18, No. 1, pp. 105-120 (1962)). Furthermore, this is also described in detail in JP-A-9-95538.

The molecular weight distribution of the cellulose acylate preferably used in the present invention is evaluated by gal permeation chromatography, and it is preferred that the polydispersity index Mw/Mn (Mw is a mass average molecular weight and Mn is a number average molecular weight) is small and the molecular weight distribution is narrow. Specifically, the Mw/Mn value is preferably from 1.0 to 3.0, more preferably from 1.0 to 2.0, and most preferably from 1.0 to 1.6.

When low molecular components of the cellulose acylate are removed, this is useful because the viscosity becomes lower than normal cellulose acylates, though the average molecular weight (polymerization degree) increases. The cellulose acylate having a small low molecular component content can be obtained by removing low molecular components from a cellulose acylate synthesized by a normal method. The low molecular components can be removed by washing the cellulose acylate with an appropriate organic solvent.

In the case of producing a cellulose acylate having a small low molecular component content, the amount of the sulfuric acid catalyst in the acetylation reaction is preferably adjusted to 0.5 to 25 parts by mass per 100 parts by mass of cellulose. When the amount of the sulfuric acid catalyst is adjusted to this range, a cellulose acylate advantageous also in terms of the molecular weight distribution (uniform molecular weight distribution) can be synthesized.

In use at the production of the cellulose acylate film of the present invention, the cellulose acylate preferably has a moisture content of 2 mass % or less, more preferably 1 mass % or less, still more preferably 0.7 mass % or less. The cellulose acylate generally contains water and the moisture content thereof is known to be approximately from 2.5 to 5 mass %. In the present invention, the cellulose acylate needs to be dried for adjusting its moisture content to the preferred range, and the method therefor is not particularly limited as long as the objective moisture content can be attained. As regards such a cellulose acylate for use in the present invention, the raw material cotton and synthesis method are described in detail in JIII Journal of Technical Disclosure, No. 2001-1745, pp. 7-12, Japan Institute of Invention and Innovation (Mar. 15, 2001).

As long as the substituent, substitution degree, polymerization degree, molecular weight distribution and the like of the cellulose acylate for use in the present invention are in the above-described ranges, a single cellulose acylate or a mixture of two or more kinds of cellulose acylates may be used.

[Other Additives to Cellulose Acylate]

In the cellulose acylate solution for use in the present invention, other than the above-described retardation adjusting agent, ultraviolet absorbent and the like, various additives (for example, a retardation developer, a retardation decreasing agent and a fine particle) can be added in each preparation step. These additives are described below. As for the timing of addition, the additives may be added at any time in the dope production process, or a step of adding additives to prepare a dope may be added as a final preparation step of the dope preparation process.

[Fine Matting Agent Particle]

In the cellulose acylate film of the present invention, a fine particle is preferably added as a matting agent. Examples of the fine particle for use in the present invention include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. Among these, a fine particle containing silicon is preferred in view of giving low turbidity, and silicon dioxide is more preferred. The fine silicon dioxide particle is preferably a fine particle having an average primary particle diameter of 20 nm or less and an apparent specific gravity of 70 g/liter or more. A fine particle having an average primary particle diameter as small as 5 to 16 nm is more preferred, because the haze of the film can be decreased. The apparent specific gravity is preferably from 90 to 200 g/liter or more, more preferably from 100 to 200 g/liter or more. As the apparent specific gravity is larger, a liquid dispersion having a higher concentration can be prepared and this is preferred in view of haze and aggregate.

The fine particle usually forms a secondary particle having an average particle diameter of 0.1 to 3.0 μm and in the film, this particle is present as an aggregate of primary particles to form irregularities of 0.1 to 3.0 μm on the film surface. The average secondary particle diameter is preferably from 0.2 to 1.5 μm, more preferably from 0.4 to 1.2 μm, and most preferably from 0.6 to 1.1 μm. As for the primary and secondary particle diameters, particles in the film are observed through a scanning electron microscope and the diameter of a circle circumscribing a particle is defined as the particle diameter. Also, 200 particles are observed by changing the site and the average value thereof is defined as the average particle diameter.

The fine silicon dioxide particle used may be a commercially available product such as “Aerosil R972”, “Aerosil R972V”, “Aerosil R974”, “Aerosil R812”, “Aerosil 200”, “Aerosil 200V”, “Aerosil 300”, “Aerosil R202”, “Aerosil OX50” and “Aerosil TT600” {all produced by Nihon Aerosil Co., Ltd.}. The fine zirconium oxide particle is commercially available under the trade name of, for example, “Aerosil R976” or “Aerosil R811” {both produced by Nihon Aerosil Co., Ltd.}, and these may be used.

Among these, “Aerosil 200V” and “Aerosil R972V” are preferred, because these are a fine silicon dioxide particle having an average primary particle diameter of 20 nm or less and an apparent specific gravity of 70 g/liter or more and provide a high effect of decreasing the coefficient of friction while maintaining low turbidity of the optical film.

In the present invention, in order to obtain a cellulose acylate film containing a particle having a small average secondary particle diameter, several techniques may be considered at the preparation of a fine particle liquid dispersion. For example, in one method, a solvent and a fine particle are mixed with stirring to previously prepare a fine particle liquid dispersion, the obtained fine particle liquid dispersion is added to a small amount of a separately prepared cellulose acylate solution and then dissolved with stirring, and the resulting solution is further mixed with a main cellulose acylate dope solution. This preparation method is preferred in that good dispersibility of the fine silicone dioxide particle is ensured and re-aggregation of the fine silicon dioxide particle scarcely occurs. In another method, a small amount of a cellulose acylate is added to a solvent and then dissolved with stirring, a fine particle is added thereto and dispersed by a disperser to obtain a fine particle-added solution, and the fine particle-added solution is thoroughly mixed with a dope solution by an in-line mixer. The present invention is not limited to these methods, but at the time of mixing and dispersing the fine silicon dioxide particle with a solvent or the like, the concentration of silicon dioxide is preferably from 5 to 30 mass %, more preferably from 10 to 25 mass %, and most preferably from 15 to 20 mass %. A higher dispersion concentration is preferred because the liquid turbidity for the amount added becomes low and the haze and aggregate are improved. In the final dope solution of cellulose acylate, the amount of the matting agent added is preferably from 0.01 to 1.0 g/m², more preferably from 0.03 to 0.3 g/m², and most preferably from 0.08 to 0.16 g/m².

As for the solvent used here, preferred examples of the lower alcohols include methyl alcohol, ethyl alcohol, propyl alcohol, isopropyl alcohol and butyl alcohol. The solvent other than the lower alcohol is not particularly limited, but the solvent used at the film formation of cellulose acylate is preferably used.

[Plasticizer]

The cellulose acylate film of the present invention may contain a plasticizer. The plasticizer which can be used is not particularly limited, but a compound more hydrophobic than cellulose acylate is preferred and examples thereof include a phosphoric acid ester type such as triphenyl phosphate, tricresyl phosphate, cresyldiphenyl phosphate, octyldiphenyl phosphate, diphenylbiphenyl phosphate, trioctyl phosphate and tributyl phosphate; a phthalic acid ester type such as diethyl phthalate, dimethoxyethyl phthalate, dimethyl phthalate, dioctyl phthalate, dibutyl phthalate and di-2-ethylhexyl phthalate; and a glycolic acid ester type such as triacetin, tributyrin, butylphthalyl butyl glycolate, ethylphthalyl ethyl glycolate, methylphthalyl ethyl glycolate and butylphthalyl butyl glycolate. One of these plasticizers may be used alone, or two or more kinds thereof may be used in combination.

In the cellulose acylate film of the present invention, other than the above-described polymer and ultraviolet absorbent, various additives (for example, a plasticizer, a deterioration inhibitor, a releasing agent and an infrared absorbent) according to usage may be added in each preparation step. These additives may be either a solid matter or an oily product. That is, the additive is not particularly limited in its melting point or boiling point. For example, mixing of ultraviolet absorbents having a melting point of 20° C. or less and a melting point of 20° C. or more, or similar mixing of plasticizers may be employed, and these are described, for example, in JP-A-2001-151901. As for the infrared absorbent, those described, for example, in JP-A-2001-194522 may be used. The amount of each material added is not particularly limited as long as its function can be brought out. In the case where the cellulose acylate film is formed from multiple layers, the kind or amount added of the additive may differ among the layers. This is a conventionally well-known technique described, for example, in JP-A-2001-151902. The materials described in detail in JIII Journal of Technical Disclosure, No. 2001-1745, pp. 16-22, Japan Institute of Invention and Innovation (Mar. 15, 2001) are preferably used.

[Ratio of Compounds Added]

In the cellulose acylate film of the present invention, the total amount of the compounds having a molecular weight of 3,000 or less is preferably from 5 to 45 mass %, more preferably from 10 to 40 mass %, still more preferably from 15 to 30 mass %, based on the mass of cellulose acylate. This compound is, as described above, a retardation adjusting agent, an ultraviolet absorbent, an ultraviolet inhibitor, a plasticizer, a deterioration inhibitor, a fine particle, a releasing agent, an infrared absorbent or the like. The molecular weight thereof is preferably 3,000 or less, more preferably 2,000 or less, still more preferably 1,000 or less. When the total amount of these compounds is not less than the lower limit above, the properties of the cellulose acylate as a single material are prevented from predominating and there is not caused a problem such as that the optical performance or physical strength readily fluctuates due to change in the temperature or humidity. On the other hand, when the total amount of these compounds is not more than the upper limit above, there does not arise a problem such as that the compounds exceed the limit allowing their compatibilization in the cellulose acylate film and precipitate on the film surface to cause white clouding of the film (bleeding from the film). Accordingly, these compounds are preferably used in a total amount falling within the above-described range. As for the timing of addition, the additives may be added at any time in the dope preparation process, or a step of adding the additives to prepare a dope may be performed as a final step of the dope preparation process.

[Organic Solvent of Cellulose Acylate Solution]

In the present invention, the cellulose acylate film is preferably produced by a solvent casting method, and in this method, the film is produced using a solution (dope) prepared by dissolving cellulose acylate in an organic solvent. The organic solvent which is preferably used as a main solvent in the present invention is preferably a solvent selected from an ester, ketone or ether having a carbon number of 3 to 12 and a halogenated hydrocarbon having a carbon number of 1 to 7. The ester, ketone and ether each may have a cyclic structure. A compound having two or more functional groups of an ester, a ketone and an ether (that is, —O—, —CO— and —COO—) may also be used as the main solvent, and the compound may have another functional group such as alcoholic hydroxyl group. In the case of a main solvent having two or more kinds of functional groups, the number of carbon atoms may suffice if it falls within the range specified for the compound having any one functional group.

For the cellulose acylate film of the present invention, a chlorine-containing halogenated hydrocarbon may be used as a main solvent or, as described in JIII Journal of Technical Disclosure, No. 2001-1745 (pp. 12-16), a chlorine-free solvent may be used as a main solvent. In this respect, the cellulose acylate film of the present invention is not particularly limited.

Other solvents for the cellulose acylate solution or film of the present invention, including the dissolution method, are described in the following patent publications, and these are preferred embodiments. The solvents are described, for example, in JP-A-2000-95876, JP-A-12-95877, JP-A-10-324774, JP-A-8-152514, JP-A-10-330538, JP-A-9-95538, JP-A-9-95557, JP-A-10-235664, JP-A-12-63534, JP-A-11-21379, JP-A-10-182853, JP-A-10-278056, JP-A-10-279702, JP-A-10-323853, JP-A-10-237186, JP-A-11-60807, JP-A-11-152342, JP-A-11-292988, JP-A-11-60752 and JP-A-11-60752. In these patent publications, not only the solvents preferred for the cellulose acylate of the present invention but also their physical properties as a solution and co-existing substances to be present together are described, and these are preferred embodiments also in the present invention.

[Production Process of Cellulose Acylate Film]

[Dissolution Step]

In the present invention, the dissolution method at the preparation of the cellulose acylate solution (dope solution) is not particularly limited and may be room-temperature dissolution, cooling dissolution, high-temperature dissolution, or a combination thereof. As for the preparation of the cellulose acylate solution in the present invention and the steps for solution concentration and filtration, associated with the dissolution step, the production process described in detail in JIII Journal of Technical Disclosure, No. 2001-1745, pp. 22-25, Japan Institute of Invention and Innovation (Mar. 15, 2001) is preferably used.

(Transparency of Dope Solution)

The transparency of the dope solution (hereinafter sometimes simply referred to as a “dope”) which is the cellulose acylate solution in the present invention is preferably 85% or more, more preferably 88% or more, still more preferably 90% or more. In the present invention, it is confirmed that various additives are sufficiently dissolved in the cellulose acylate dope solution. As regards the specific method for calculating the dope transparency, the dope solution is poured in a 1 cm-square glass cell, and the absorbance at 550 nm is measured using a spectrophotometer “UV-3150” {manufactured by Shimadzu Corp.}. The absorbance of the solvent alone is previously measured as a blank, and the transparency of the dope is calculated from the ratio between the absorbance of the blank and the absorbance of the dope.

[Casting, Drying and Taking-up Steps]

The film production method using the cellulose acylate solution (dope) in the present invention is described below. As regards the method and equipment for producing the cellulose acylate film of the present invention, the solution casting film-formation method and solution casting film-formation apparatus conventionally employed for the production of a cellulose triacetate film are used. The dope (cellulose acylate solution) prepared in a dissolving machine (kettle) is once stored in a storing kettle and finalized by removing the bubbles contained in the dope. The dope is supplied to a pressure-type die from the dope discharge port through, for example, a pressure-type quantitative gear pump capable of feeding a constant amount of solution with high precision by the number of rotations, and uniformly cast on an endlessly running metal support in the casting part from the mouth ring (slit) of the pressure-type die, and the damp-dry dope film (also called web) is peeled off from the metal support at the peeling point after nearly one round of the metal support. The obtained web is nipped by clips at both ends, conveyed by a tenter while keeping the width and thereby dried, and subsequently, the obtained film is mechanically conveyed by a roll group of a drying apparatus to complete the drying and then taken up into a roll of a predetermined length by a take-up machine. The combination of the tenter and the drying apparatus comprising a roll group varies depending on the purpose. In the solution casting film formation method used for a functional protective film as an optical member of an electronic display, which is the main usage of the cellulose acylate film of the present invention, or used for a silver halide photographic light-sensitive material, in addition to the solution casting film formation apparatus, a coating apparatus is added in many cases so as to apply surface treatment to the film, such as subbing layer, antistatic layer, antihalation layer and protective layer. These are described in detail in JIII Journal of Technical Disclosure, No. 2001-1745, pp. 25-30, Japan Institute of Invention and Innovation (Mar. 15, 2001), with categories of dissolution, casting (including co-casting), metal support, drying, separation, stretching and the like, and the contents therein can be preferably used in the present invention.

In the cellulose acylate film of the present invention, the residual solvent content at an arbitrary point in the casting film formation process is defined by the following formula (6):
(Wₜ−W₀)×100/W₀ Formula (6):
wherein

Wₜ: the measured mass of dope film, and

W₀: the mass of film further dried at 110° C. for 3 hours after the completion of drying.

The residual solvent content at the peeling point is preferably from 5 to 90 mass %, and the bad solvent content preferably occupies from 10 to 95 mass % in the residual solvent.

[Stretching of Cellulose Acylate Film]

The retardation of the cellulose acylate film can be adjusted by stretching. The stretch ratio is preferably from 3 to 100%.

As for the stretching method, a known method may be used within the scope of not departing from the above-described range, but in view of in-plane uniformity, tenter stretching is particularly preferred. The cellulose acylate film of the present invention preferably has a width of at least 100 cm or more, and the fluctuation of the Re value in the full width is preferably ±5 nm, more preferably ±3 nm. Also, the fluctuation of the Rth value is preferably ±10 mm more preferably ±5 nm. Furthermore, the fluctuations of the Re value and Rth value in the length direction are also preferably in respective fluctuation ranges for the width direction.

The stretching may be performed on the way of film-formation process or the stock film produced and taken up may be stretched. In the former case, the film may be stretched in the state of containing a residual solvent and can be preferably stretched when the residual solvent amount is from 2 to 30 mass %. At this time, the film is preferably stretched in the direction orthogonal to the longitudinal direction while conveying the film in the longitudinal direction, so that the slow axis of the film can cross at right angles with the longitudinal direction of the film.

As for the stretching temperature, an appropriate condition may be selected according to the residual solvent amount at stretching and the film thickness. In the case of stretching the film in a state of containing a residual solvent, the film is preferably dried after stretching. The drying may be performed according to the method described above in regard to the film formation.

[Film Thickness]

The thickness of the cellulose acylate film of the present invention is preferably from 10 to 120 μm, more preferably from 20 to 100 μm, still more preferably from 30 to 90 μm. Also, in the cellulose acylate film of the present invention, the difference between the maximum value and the minimum value of the thickness in a 1 m-square film arbitrarily cut out is preferably 10% or less, more preferably 5% or less, based on the average thickness value.

[Evaluation of Physical Properties of Cellulose Acylate Film]

[Optical Performance]

(Change of Optical Performance of Film After High-Humidity Treatment)

As for the change in optical performance of the cellulose acylate film of the present invention due to environmental change, the variation of Re and Rth of the film treated at 60° C. and 90% RH for 240 hours is preferably 15 nm or less, more preferably 12 nm or less, still more preferably 10 nm or less.

(Change of Optical Performance of Film After High-Temperature Treatment)

The variation of Re and Rth of the film treated at 80° C. for 240 hours is preferably 15 nm or less, more preferably 12 nm or less, still more preferably 10 nm or less.

(Humidity Dependency of Re and Rth of Film)

The retardation Rth in the thickness direction of the cellulose acylate film of the present invention preferably less changes due to humidity. Specifically, the difference ΔRth between the Rth value at 25° C. and 10% RH and the Rth value at 25° C. and 80% RH, represented by the following formula (7), is preferably from 0 to 50 nm, more preferably from 0 to 40 nm, still more preferably from 0 to 35 nm.
ΔRth=Rth_{10% RH}−Rth_{80% RH} Formula (7):
(In-Plane Fluctuation of Retardation of Cellulose Acylate Film)

In the cellulose acylate film of the present invention, the Re and Rth values at a wavelength of 630 nm preferably satisfy the relationship of the following formula (8), more preferably the relationship of the following formula (8-1).
|Re₍₆₃₀₎ₘₐₓ−Re₍₆₃₀₎ₘᵢₙ|≦5 and |Rth₍₆₃₀₎ₘₐₓ−Rth₍₆₃₀₎ₘᵢₙ|≦10 Formula (8):
|Re₍₆₃₀₎ₘₐₓ−Re₍₆₃₀₎ₘᵢₙ|≦3 and |Rth₍₆₃₀₎ₘₐₓ−Rth₍₆₃₀₎ₘᵢₙ≦5 Formula (8-1):
{wherein Re₍₆₃₀₎ₘₐₓ and Rth₍₆₃₀₎ₘₐₓ are the maximum retardation value at a wavelength of 630 nm in a 1 m-square film arbitrarily cut out, and Re₍₆₃₀₎ₘᵢₙ and Rth₍₆₃₀₎ₘᵢₙ are the minimum retardation value at a wavelength of 630 nm}.
(Photoelastic Coefficient)

The photoelastic coefficient of the cellulose acylate film of the present invention is preferably 50×10⁻¹³ cm²/dyne or less, more preferably 30×10⁻¹³ cm²/dyne or less, still more preferably 20×10⁻¹³ cm²/dyne or less. As for the specific measuring method, a tensile stress is applied to the long axis direction of a cellulose acylate film sample of 12 mm×120 mm, and the retardation at this time is measured by an ellipsometer “M150” {manufactured by JASCO Corporation}. The photoelastic coefficient is calculated from the variation of retardation based on the stress.

(Haze of Film)

The haze of the cellulose acylate film of the present invention is preferably from 0.01 to 2%. The haze can be measured here as follows.

In the measurement of haze, a cellulose acylate film sample of 40 mm×80 mm of the present invention is measured according to JIS K-6714 by means of a haze meter (HGM-2DP, manufactured by Suga Test Instruments Co., Ltd.) at 25° C. and 60% RH.

A sample of 40 mm×80 mm is measured according to JIS K-6714 by a haze meter (HGM-2DP, manufactured by Suga Test Instruments Co., Ltd.) at 25° C. and 60% RH.

(Spectroscopic Properties, Spectral Transmittance)

A cellulose acylate film sample of 13 mm×40 mm is measured by a spectrophotometer “U-3210” {manufactured by Hitachi, Ltd.} at 25° C. and 60% RH to determine the transmittance at a wavelength of 300 to 450 nm. The tilt width is determined as (wavelength at 72%−wavelength at 5%). The limiting wavelength is represented by (tilt width/2)+wavelength at 5%. The absorption end is expressed by the wavelength at a transmittance of 0.4%. From these, the transmittances at 380 nm and 350 nm are evaluated.

In the cellulose acylate film of the present invention, it is preferred that the spectral transmittance at a wavelength of 400 nm is from 45 to 95% and the spectral transmittance at a wavelength of 350 nm is 10% or less.

[Physical Properties]

(Glass Transition Temperature Tg of Film)

In the measurement of the glass transition temperature (Tg), the calorie measurement is performed using 10 mg of a cellulose acylate film sample of the present invention by a differential scanning calorimeter “DSC2910” (manufactured by T.A. Instruments) at a temperature rising rate of 5° C./min from ordinary temperature to 200° C., and the glass transition temperature (Tg) is calculated.

The glass transition temperature (Tg) of the cellulose acylate film of the present invention is preferably from 80 to 165° C. In view of heat resistance, Tg is more preferably 100 to 160° C., still more preferably from 110 to 150° C.

(Equilibrium Moisture Content of Film)

As for the equilibrium moisture content of the cellulose acylate film of the present invention, at the time of using the film as a protective film of a polarizing plate, the equilibrium moisture content at 25° C. and 80% RH is preferably from 0 to 4%, more preferably from 0.1 to 3.5%, still more preferably from 1 to 3%, irrespective of the film thickness so as not to impair the adhesive property with a water-soluble polymer such as polyvinyl alcohol. When the equilibrium moisture content is 4% or less, the dependency of retardation on humidity change on use as the support of an optically-compensatory film does not become excessively large and this is preferred.

As for the measuring method of the moisture content, a cellulose acylate film sample of 7 mm×35 mm of the present invention is measured by the Karl Fischer's method using a water content measuring meter and a sample drying apparatus, “CA-03” and “VA-05 {both manufactured by Mitsubishi Chemical Corp.}. The moisture content is calculated by dividing the water content (g) by the sample mass (g).

(Moisture Permeability of Film)

The moisture permeability is determined by measuring the film under the conditions of 60° C. and 95% RH according to JIS Z-0208 and converting the value in terms of the film having a thickness of 80 μm.

The moisture permeability becomes smaller as the thickness of the cellulose acylate film is larger, and the moisture permeability becomes larger as the film thickness is smaller. Accordingly, whatever thickness the sample has, the value needs to be converted by setting a reference to 80 μm. The film thickness can be converted according to the following formula (9):
80 μm-reduced moisture permeability=measured moisture permeability×measured film thickness (μm)/80 (μm) Formula (9):

As for the measuring method of moisture permeability, the methods described in “Measurement of Amount of Vapor Permeated (weighing method, thermometer method, vapor pressure method, adsorption amount method)” of Kobunshi Jikken Koza 4, Kobunshi no Bussei II (Polymer Experiment Lecture 4, Physical Properties II of Polymers), pp. 285-294, Kyoritsu Shuppan, can be applied.

Specifically, a cellulose acylate film sample of 70 mmφ of the present invention is humidity-conditioned at 60° C. and 95% RH for 24 hours, the water content per unit area (g/m²) is calculated according to JIS Z-0208 by a moisture permeability tester “KK-709007” {manufactured by Toyo Seiki Seisaku-Sho, Ltd.}, and the moisture permeability is determined according to the following formula (10).
moisture permeability=mass after humidity conditioning−mass before humidity conditioning Formula (10):

The moisture permeability of the cellulose acylate film of the present invention is preferably from 400 to 2,000 g/m²·24 hr, more preferably from 500 to 1,800 g/m²·24 hr, still more preferably from 600 to 1,600 g/m²·24 hr. When the moisture permeability is 2,000 g/m²·24 hr or less, there is not caused a trouble such as that the humidity dependency of Re value and Rth value of the film exceeds 0.5 nm/% RH in terms of the absolute value. Also, even when an optically anisotropic layer is stacked on the cellulose acylate film of the present invention to produce an optically-compensatory film, the humidity dependency of Re value and Rth value does not exceed 0.5 nm/% RH in terms of the absolute value and this is preferred. Furthermore, even when an optically-compensatory film or polarizing plate producing using such a film is incorporated into a liquid crystal display device, tint change or decrease of the viewing angle is advantageously not brought about. On the other hand, when the moisture permeability of the cellulose acylate film is 400 g/m²·24 hr or more, at the time of producing a polarizing plate by laminating the film to both surfaces or the like of a polarizer, the adhesive is not prevented from drying by the cellulose acylate film and can exert excellent adhesive property and this is preferred.

(Dimensional Change of Film)

As for the dimensional stability of the cellulose acylate film of the present invention, both the rate of dimensional change when the film is left standing at 60° C. and 90% RH for 24 hours (high humidity), and the rate of dimensional change when the film is left standing at 90° C. and 5% RH for 24 hours (high temperature), are preferably 0.5% or less, more preferably 0.3% or less, still more preferably 0.15% or less.

In the specific measuring method, two sheets of the cellulose acylate film sample of 30 mm×120 mm are prepared and humidity-conditioned at 25° C. and 60% RH for 24 hours, 6 mmφ holes are punched on both ends at a distance of 100 mm, and this is defined as the original dimension (L₀) of punch distance. The dimension (L₁) of punch distance after one sample sheet is treated at 60° C. and 90% RH for 24 hours is measured, and the dimension (L₂) of punch distance after another sample sheet is treated at 90° C. and 5% RH for 24 hours is measured. In the measurement of all distances, the distance is measured to a minimum scale, that is, 1/1,000 mm, and the rate of dimensional change is determined by the following formulae (11) and (12).
Rate of dimensional change at 60° C. and 90% RH (high humidity)={|L₀−L₁|/L₀}×100 Formula (11):
Rate of dimensional change at 90° C. and 5% RH (high temperature)={|L₀−L₂|/L₀}×100 Formula (12):
(Elastic Modulus of Film)

The elastic modulus of the cellulose acylate film of the present invention is preferably from 200 to 500 kgf/mm², more preferably from 240 to 470 kgf/mm², still more preferably from 270 to 440 kgf/mm². In the specific measuring method, the stress in the elongation of 0.5% at a tensile rate of 10%/min in an atmosphere of 23° C. and 70% RH is measured using a universal tensile tester “STM T50BP” manufactured by Toyo Baldwin Co., Ltd., and the elastic modulus is determined.

[Surface Profile of Film]

The cellulose acylate film of the present invention preferably has a surface where the arithmetic average roughness (Ra) of surface irregularities of the film according to JIS B0601-1994 is 0.1 μm or less and the maximum height (Ry) is 1 μm or less, more preferably a surface where the arithmetic average roughness (Ra) is 0.05 μm or less and the maximum height (Ry) is 0.5 μm or less, and most preferably a surface where the arithmetic average roughness (Ra) is 0.03 μm or less and the maximum height (Ry) is 0.3 μm or less. The concave and convex shapes on the film surface can be evaluated using an atomic force microscope (AFM).

[Compound Retentivity of Film]

The cellulose acylate film of the present invention is required to retain various compounds added to the film, such as plasticizer and ultraviolet absorbent.

(Compound Retentivity After High-Temperature High-Humidity Treatment of Film)

When the cellulose acylate film of the present invention left standing under the conditions of 80° C. and 90% RH for 48 hours, the change of mass is preferably from 0 to 5%, more preferably from 0 to 3 mass %, still more preferably from 0 to 2%.

(Evaluation Method of Retentivity)

A cellulose acylate film sample is cut into a size of 10 cm×10 cm, the mass after standing in an atmosphere of 23° C. and 55% RH for 24 hours is measured, and the sample is then left standing under the conditions of 80±5° C. and 90±10% RH for 48 hours. The surface of the sample after treatment is lightly wiped, the mass after standing at 23° C. and 55% RH for one day is measured, and the compound retentivity after high-temperature high-humidity treatment is calculated according to the following formula (13).
Compound retentivity (mass %)={(mass before standing−mass after standing)/mass before standing}×100 Formula (13):
[Dynamic Properties of Film]
(Curl)

The curl value in the width direction of the cellulose acylate film of the present invention is preferably from −10/m to +10/m.

When the curl value in the width direction of the cellulose acylate film of the present invention is within the above-described range, even if the film is in the form of a lengthy film and subjected to surface treatment, rubbing treatment on providing an optically anisotropic layer, or coating or lamination of an orientation film or an optically anisotropic layer, which are described later, there is not caused a problem such as occurrence of film breakage due to failure in the handling of film or a problem such as that the film is dusted due to strong contacted with the conveying roller at the edges or center of the film, resulting in increase of foreign matters adhering on the film, and the frequency of point defects or coating streaks on the optically-compensatory film exceeds the acceptable value. Also, when the curl is within the above-described range, not only the failure of color unevenness which is liable to occur when providing an optically anisotropic layer can be reduced but also entrainment of air bubbles can be prevented at the lamination of a polarizer and this is preferred.

The curl value can be measured according to the measuring method (ANSI/ASCPH1.29-1985) prescribed by American National Standard Institute.

(Tear Strength)

The tear strength of the film can be measured according to the tear testing method of JIS K7128-2:1998 by using a light load tear strength tester (manufactured by Toyo Seiki Seisaku-Sho, Ltd.) after a sample strip of 50 mm×64 mm is humidity-conditioned under the conditions of 25° C. and 65% RH for 2 hours (Elmendorf tear method).

When the thickness of the cellulose acylate film of the present invention is from 20 to 80 μm, the tear strength of the film of the present invention is preferably 2 g or more, more preferably from 5 to 25 g, still more preferably from 6 to 25 g. The tear strength in terms of a 60 μm-thick film is preferably 8 g or more, more preferably from 8 to 15 g.

[Residual Solvent Amount of Film]

The cellulose acylate film of the present invention is preferably dried under the conditions such that the residual solvent amount at the film formation becomes from 0.01 to 1.5 mass %, more preferably from 0.01 to 1.0 mass %, based on the film. In the case of using the cellulose acylate film of the present invention as a transparent support of, for example, an antireflection film or an optically-compensatory film, when the residual solvent amount is 1.5% or less, the curling can be suppressed. The solvent residual amount is more preferably 1.0 mass % or less. By virtue of reducing the residual solvent amount at the film formation in the above-described solvent casting method using a dope, the free volume is decreased, and this is considered to be the main factor of the effect.

[Hygroscopic Expansion Coefficient of Film]

In the measurement of the hygroscopic expansion coefficient, the dimension of a film left standing under 25° C. and 80% RH for 2 hours is measured by “Pin-Gauge EF-PH” {manufactured by Mitsutoyo} to obtain a value L₈₀, the dimension of a film left standing under 25° C. and 10% RH for 2 hours is similarly measured to obtain a value L₁₀, and from these measured values, the hygroscopic expansion coefficient is determined according to the following formula (14):
Hygroscopic expansion coefficient=(L₁₀−L₈₀)/L₁₀/(80−10) [unit: (% RH)⁻¹] Formula (14):

The hygroscopic expansion coefficient indicates the ratio of change in the sample length when the relative humidity is varied at a constant temperature.

The hygroscopic expansion coefficient of the cellulose acylate film of the present invention is preferably 30×10⁻⁵% RH or less, more preferably 15×10⁻⁵% RH, still more preferably 10×10⁻⁵% RH or less. The hygroscopic expansion coefficient is preferably smaller but is usually 1.0×10⁻⁵% RH or more. Also, the hygroscopic expansion coefficient is preferably almost the same between the machine direction and the vertical direction.

[Surface Treatment]

The cellulose acylate film of the present invention is surface-treated depending on the case, whereby the adhesion of the cellulose acylate film to each functional layer (for example, an undercoat layer or a back layer) can be enhanced. Examples of the surface treatment which can be used include glow discharge treatment, ultraviolet irradiation treatment, corona treatment, flame treatment and acid or alkali treatment.

The glow discharge treatment as used herein may be a low-temperature plasma occurring in a low-pressure gas of 10⁻³ to 20 Torr. A plasma treatment under an atmospheric pressure is also preferred. The plasma-exciting gas means a gas which is plasma-excited under such a condition, and examples thereof include argon, helium, neon, krypton, xenon, nitrogen, carbon dioxide, chlorofluorocarbons such as tetrafluoromethane, and a mixture thereof. These are described in detail in JIII Journal of Technical Disclosure, No. 2001-1745, pp. 30-32, Japan Institute of Invention and Innovation (Mar. 15, 2001). Those described in this publication can be preferably used in the present invention.

(Saponification Treatment)

In the case of using the cellulose acylate film of the present invention as a transparent protective film of a polarizing plate, one of the effective means for the surface treatment is an alkali saponification treatment.

The alkali saponification treatment is specifically described below.

The alkali saponification treatment of the cellulose acylate film is preferably performed by a cycle consisting of dipping of the film surface in an alkali solution, neutralization with an acidic solution, water-washing and drying. The alkali solution includes a potassium hydroxide solution and a sodium hydroxide solution, and the hydroxide ion concentration is preferably from 0.1 to 5.0 mol/L, more preferably from 0.5 to 4.0 mol/L. The temperature of the alkali solution is preferably from room temperature to 90° C., more preferably from 40 to 70° C.

In the cellulose acylate film of the present invention, the contact angle of the film surface after the alkali saponification is preferably 55° or less, more preferably 50° or less, still more preferably 45° or less. The evaluation method of the contact angle can be used for evaluating the hydrophilicity/hydrophobicity by an ordinary technique of dropping a 3 mm-diameter water droplet on the alkali-saponified film surface and determining the angle made by the film surface and the water droplet.

The surface energy of a solid matter can be generally determined by a contact angle method, a wetting heat method or an adsorption method as described in Nure No Kiso To Oyo (Foundations and Applications of Wetting), Realize Sha (Dec. 10, 1989). In the case of the cellulose acylate film of the present invention, a contact angle method is preferably used. More specifically, two kinds of solutions each having a known surface energy are dropped on the cellulose acylate film, and by defining the contact angle as an angle including the liquid droplet out of the angles made by a tangent drawn on the liquid droplet with the film surface at an intersection point between the liquid droplet surface and the film surface, the surface energy of the film can be calculated by computation.

(Change of Re and Rth Values Between Before Saponification of Film Surface and After Saponification)

In the cellulose acylate film of the present invention, the change of Re and Rth values at a wavelength of 630 nm between before and after saponification of the film surface with an alkali solution preferably satisfies the relationship of the following formula (15), more preferably the relationship of formula (15-1), still more preferably the relationship of formula (15-2).
|Re(630)F−Re(630)S|≦10 and |Rth(630)F−Rth(630)S|≦20 Formula (15):
|Re(630)F−Re(630)S|≦8 and |Rth(630)F−Rth(630)S|≦15 Formula (15-1):
|Re(630)F−Re(630)S|≦5 and |Rth(630)F−Rth(630)S|≦10 Formula (15-2):

In the formulae above, Re(630)F represents Re at a wavelength of 630 nm before saponification with an alkali solution, Re(630)S represents Re at a wavelength of 630 nm after saponification with an alkali solution, Rth(630)F represents Rth at a wavelength of 630 nm before saponification with an alkali solution, and Rth(630)S represents Rth at a wavelength of 630 nm after saponification with an alkali solution.

Within the above-described range, the optical performance of the protective film is good and when applied to a polarizing plate, an optically-compensatory film or a liquid crystal display device, light leakage does not occur and this is preferred.

Incidentally, unless otherwise indicated, the specific alkali saponification treatment as used in the present invention indicates a procedure of dipping a film sample of 10 cm×10 cm in an aqueous sodium hydroxide solution of 1.5 mol/L at 55° C. for 2 minutes and subjecting the film sample to neutralization with a sulfuric acid solution of 0.05 mol/L at 30° C., washing in a water-washing bath at room temperature and drying at 100° C.

[Light Resistance]

As an index for light durability of the cellulose acylate film of the present invention, the fluctuation of the Rth value of a film irradiated with light of Super Xenon for 200 hours is measured. In the irradiation of xenon light, a cellulose acylate film alone is irradiated with xenon light at 250,000 lux for 200 hours by using Super Xenon Weather Meter “SX-75” {manufactured by Suga Test Instruments Co., Ltd.; under the conditions of 60° C. and 50% RH}. After passing of a predetermined time, the film is taken out from the constant-temperature bath, then humidity-conditioned in the same manner as above and measured.

A color difference ΔE*a*b* may also be used as an index for light durability and when light of Super Xenon is irradiated under the same conditions as above, the color difference ΔE*a*b* between before and after the irradiation is preferably 20 or less, more preferably 18 or less, still more preferably 15 or less.

In the measurement of color difference, “UV3100” {manufactured by Shimadzu Corp.} is used. The measurement is performed in the following manner. The film is humidity-conditioned at 25° C. and 60% RH for 2 hours or more, the color of the film before the irradiation of xenon light is measured to determine the initial values (L₀*, a₀*, b₀*), xenon light is irradiated on the film alone under the conditions of 60° C. and 50% RH, the film is taken out from the constant-temperature bath after passing of a predetermined time, the film is humidity-conditioned at 25° C. and 60% RH for 2 hours, and the color is again measured to determine the values (L₁*, a₁*, b₁*) after irradiation aging. From the values obtained, the color difference ΔE*a*b* is determined according to the following formula (16).
ΔE*a*b*=[(L₀*−L₁*)²+(a₀*−a₁*)²+(b₀*−b₁*)²]^{1/2} Formula (16):

In the test above, light of Super Xenon is irradiated under the same conditions, and compounds such as retardation adjusting agent are extracted using a solvent such as tetrahydrofuran from the cellulose acylate film before and after the irradiation and subjected to detection and quantitative determination by high-performance liquid chromatography. Incidentally, in the present invention, carbon arc irradiation which is a similar accelerated test may also be used for the test of light resistance.

<Usage of Cellulose Acylate Film>

[Optical Usage]

As for usage, the cellulose acylate film of the present invention is applied to optical usage or a photographic light-sensitive material. In particular, optical usage of using the cellulose acylate film of the present invention for a liquid crystal display is preferred. The liquid crystal display device generally has a constitution that a liquid crystal cell carries a liquid crystal between two electrode substrates and two polarizing plates are disposed on both sides of the liquid crystal cell. The cellulose acylate film of the present invention is more preferably used as a protective film of the polarizing plate or used for a liquid crystal display device after imparting a functional layer described later. The liquid crystal display device is preferably TN, IPS, FLC, AFLC, OCB, STN, ECB, VA or HAN.

[Functional Layer]

In the case of using the cellulose acylate film of the present invention for optical usage as above, various functional layers can be provided on the film. Examples of the functional layer include an antistatic layer, a cured resin layer (transparent hardcoat layer), an antireflection layer, an easily adhesive layer, an antiglare layer, an optically-compensatory layer, an orientation layer and a liquid crystal layer. In such a functional layer, a surfactant, a slipping agent, a matting agent, a filler, a dye and the like can be added. The functional group applicable to the transparent film of the present invention includes those described in JIII Journal of Technical Disclosure, No. 2001-1745, pp. 32-45, Japan Institute of Invention and Innovation (Mar. 15, 2001).

Also in the case of using the cellulose acylate film of the present invention for other uses, a functional layer such as undercoat layer and back layer may be provided on the transparent film.

[Usage (Polarizing Plate)]

The usage of the cellulose acylate film of the present invention is described below.

The cellulose acylate film of the present invention is particularly useful as a polarizing plate protective film. In the case of using the cellulose acylate film of the present invention as a polarizing plate protective film, the polarizing plate is not particularly limited in its production method and can be produced by a general method. A method of alkali-treating the cellulose acylate film obtained, producing a polarizer by dipping a polyvinyl alcohol film in an iodine solution and stretching the film, and laminating the alkali-treated film on both surfaces of the polarizer by using an aqueous solution of completely saponified polyvinyl alcohol or the like may be used. In place of the alkali treatment, an easy adhesion process described in JP-A-6-94915 and JP-A-6-118232 may be applied.

Examples of the adhesive used for laminating the protective film-treated surface to the polarizer include a polyvinyl alcohol-based adhesive such as polyvinyl alcohol and polyvinyl butyral, and a vinyl-based latex such as butyl acrylate.

The polarizing plate comprises a polarizer and protective films protecting both surfaces of the polarizer. Furthermore, a protect film is laminated on one surface of the polarizing plate and a separate film is laminated on the opposite surface. The protect film and separate film are used for protecting the polarizing plate, for example, at the shipment of polarizing plate or at the inspection of product. In this case, the protect film is laminated for protecting the polarizing plate surface and used on the side opposite the surface through which the polarizing plate is laminated to a liquid crystal plate. The separate film is used for covering the adhesive layer which is laminated to the liquid crystal cell, and used on the side of the surface through which the polarizing plate is laminated to the liquid crystal plate.

In a liquid crystal display device, a substrate containing a liquid crystal between two polarizing plates is generally disposed and on whatever site the polarizing plate protective film utilizing the cellulose acylate film of the present invention is disposed, excellent display property can be obtained. In particular, a transparent hardcoat layer, an antiglare layer, an antireflection layer and the like are provided on a polarizing plate protective film as the outermost surface on the display side of a liquid crystal display device and therefore, the polarizing plate protective film described above is preferably used in this portion.

[Usage (Optically-Compensatory Film)]

The cellulose acylate film of the present invention can be applied to various uses and is particularly effective when used as the support of an optically-compensatory film of a liquid crystal display device. Incidentally, the optically-compensatory film indicates an optical material generally used in a liquid crystal display device to compensate for the phase difference and has the same meaning as a retardation plate, an optically-compensatory sheet or the like. The optically-compensatory film has a birefringent property and is used for the purpose of removing the coloring of display screen of a liquid crystal display device or improving the viewing angle properties.

Accordingly, in the case of using the cellulose acylate film of the present invention for the optically-compensatory film of a liquid crystal display device, Re and Rth of the optically anisotropic layer used in combination are preferably Re=0 to 200 nm and |Rth|=0 to 400 nm. Within this range, any optically anisotropic layer may be used.

The liquid crystal display device where the cellulose acylate film of the present invention is used is not limited in the optical performance of liquid cell or the driving system, and any optically anisotropic layer required as an optically-compensatory film may be used in combination. The optically anisotropic layer used in combination may be formed of a composition containing a liquid crystalline compound or may be formed of a polymer film having birefringence.

(Optically Anisotropic Layer Containing Liquid Crystalline Compound)

In the case of using an optically anisotropic layer containing a liquid crystalline compound, the liquid crystalline compound is preferably a discotic liquid crystalline compound or a rod-like liquid crystalline compound.

(Discotic Liquid Crystalline Compound)

Examples of the discotic liquid crystalline compound usable in the present invention include the compounds described in various publications [e.g., C. Destrade et al., Mol. Crysr. Lig. Cryst., Vol. 71, page 111 (1981); Kikan Kagaku Sosetsu (Quarterly Chemistry Survey), No. 22, “Ekisho no Kagaku (The Chemistry of Liquid Crystal)”, Chapter 5 and Chapter 10, Section 2, Nippon Kagaku Kai (compiler) (1994); B. Kohne et al., Angew. Chem. Soc. Chem. Comm., page 1794 (1985); J. Zhang et al., J. Am. Chem. Soc., Vol. 116, page 2655 (1994)].

In the optically anisotropic layer, the molecules of the discotic liquid crystalline compound are preferably fixed in an aligned state and most preferably fixed by a polymerization reaction. The polymerization of the discotic liquid crystalline compound is described in JP-A-8-27284. In order to fix the discotic liquid crystalline compound by polymerization, a polymerizable group needs to be bonded as a substituent to a discotic core of the discotic liquid crystalline compound. However, if the polymerizable group is bonded directly to the discotic core, the aligned state can be hardly maintained in the polymerization reaction. Therefore, a linking group is introduced between the discotic core and the polymerizable group. The discotic liquid crystalline compound having a polymerizable group is disclosed in JP-A-2001-4387.

(Rod-Like Liquid Crystalline Compound)

Examples of the rod-like liquid crystalline compound usable in the present invention include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolans and alkenylcyclohexylbenzonitriles. Not only these low-molecular liquid crystalline compounds but also a polymer liquid crystalline compound can be used.

In the optically anisotropic layer, the molecules of the rod-like liquid crystalline are preferably fixed in an aligned state and most preferably fixed by a polymerization reaction. Examples of the polymerizable rod-like liquid crystalline compound usable in the present invention include the compounds described in Makromol. Chem., Vol. 190, page 2255 (1989), Advanced Materials, Vol. 5, page 107 (1993), U.S. Pat. Nos. 4,683,327, 5,622,648 and 5,770,107, International Publication Nos. (WO)95/22586 pamphlet, 95/24455 pamphlet, 97/00600 pamphlet, 98/23580 pamphlet, and 98/52905 pamphlet, JP-A-1-272551, JP-A-6-16616, JP-A-7-110469, JP-A-11-80081 and JP-A-2001-328973.

(Optically Anisotropic Layer Comprising Polymer Film)

As described above, the optically anisotropic layer for use in the present invention may be formed of a polymer film. The polymer film is formed from a polymer capable of developing optical anisotropy. Examples of such a polymer include a polyolefin (e.g., polyethylene, polypropylene, norbornene-based polymer), a polycarbonate, a polyarylate, a polysulfone, a polyvinyl alcohol, a polymethacrylic acid ester, a polyacrylic acid ester and a cellulose ester (e.g., cellulose triacetate, cellulose diacetate). Also, a copolymer or mixture of these polymers may be used.

The optical anisotropy of the polymer film is preferably obtained by stretching. The stretching is preferably uniaxial stretching or biaxial stretching. More specifically, longitudinal uniaxial stretching utilizing the peripheral velocity difference of two or more rolls, tenter stretching of stretching the polymer film in the width direction by gripping both sides, or biaxial stretching using these in combination is preferred. It is also possible to use two or more sheets of the polymer film such that the optical property of the entire film comprising two or more sheets of the polymer film satisfies the above-described conditions. The polymer film is preferably produced by a solvent casting method so as to reduce unevenness of the birefringence. The thickness of the polymer film is preferably from 20 to 500 μm, and most preferably from 40 to 100 μm.

A method where at least one polymer material selected from the group consisting of polyamide, polyimide, polyester, polyether ketone, polyamidoimide polyesterimide and polyaryl ether ketone is used as the polymer film forming the optically anisotropic layer, a solution obtained by dissolving the polymer material in a solvent is coated on a substrate, and a film is formed by drying the solvent, is also preferred.

At this time, a technique of stretching the polymer film and the substrate to develop the optical anisotropy and using the stretched film as the optically anisotropic layer may also be preferably used. The cellulose acylate film of the present invention can be preferably used as the substrate in this case. It is also preferred that the polymer film is produced on a different substrate and after separating the polymer film from the substrate, laminated with the cellulose acylate film of the present invention, and the laminate is used as the optically anisotropic layer. According to this technique, the thickness of the polymer film can be made small, and the thickness is preferably 50 μm or less, more preferably from 1 to 20 μm.

[General Construction of Liquid Crystal Display Device]

In the case of using the cellulose acylate film for the optically-compensatory film, the transmission axis of the polarizing element and the slow axis of the optically-compensatory film comprising the cellulose acylate film may be arranged at any angle. The liquid crystal display device has a construction that a liquid crystal cell carries a liquid crystal between two electrode substrates, two polarizing elements are disposed on both sides of the liquid crystal cell, and at least one optically-compensatory film is disposed between the liquid crystal cell and the polarizing element.

The liquid crystal layer of the liquid crystal cell is usually formed by interposing a spacer between two substrates and enclosing a liquid crystal in the space formed. The transparent electrode layer is formed on the substrate, as a transparent film containing an electrically conducting substance. In the liquid crystal cell, a gas barrier layer, a hardcoat layer and an undercoat layer (used for adhesion of the transparent electrode layer) may be further provided. These layers are usually provided on the substrate. The substrate of the liquid crystal cell generally has a thickness of 50 μm to 2 mm.

(Kind of Liquid Crystal Display Device)

The cellulose acylate film of the present invention can be used for liquid crystal cells in various display modes. There have been proposed various display modes such as TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned), ECB (electrically controlled birefringence) and HAN (hybrid aligned nematic). A display mode modified by orientation-dividing the display mode above is also proposed. The cellulose acylate film of the present invention is effective for a liquid crystal display device in any display mode and also effective for any liquid crystal display device of transmission type, reflection type or transflection type.

(TN-Type Liquid Crystal Display Device)

The cellulose acylate film of the present invention may be used as the support of an optically-compensatory film or the protective film of a polarizing plate in a TN-type liquid crystal display device having a TN-mode liquid crystal cell. The TN-mode liquid crystal cell and the TN-type liquid crystal display device are conventionally well known. The optically-compensatory film for use in the TN-type liquid crystal display device is described in JP-A-3-9325, JP-A-6-148429, JP-A-8-50206, JP-A-9-26572, and the articles by Mori et al. (Jpn. J. Appl. Phys., Vol. 36, pages 143 and 1068 (1997)).

(STN-Type Liquid Crystal Display Device)

The cellulose acylate film of the present invention may be used as the support of an optically-compensatory film in an STN-type liquid crystal display device having an STN-mode liquid crystal cell. In the STN-type liquid crystal display device, the molecules of a rod-like liquid crystalline compound in the liquid crystal cell are generally twisted in the range from 90 to 360°, and the product (Δn·d) of the refractive index anisotropy (Δn) of the rod-like liquid crystalline compound and the cell gap (d) is from 300 to 1,500 nm. The optically-compensatory film for use in the STN-type liquid crystal display device is described in JP-A-2000-105316.

(VA-Type Liquid Crystal Display Device)

The cellulose acylate film of the present invention may be used as the support of an optically-compensatory film in a VA-type liquid crystal display device having a VA-mode liquid crystal cell. The optically-compensatory film for use in the VA-type liquid crystal display device preferably has a retardation Re value of 0 to 150 nm and a retardation Rth value of 70 to 400 nm. The retardation Re value is more preferably from 20 to 70 nm. In the case of using two sheets of the optically anisotropic polymer film for the VA-type liquid crystal display device, the retardation Re value of the film is preferably from 70 to 250 nm. In the case of using one sheet of the optically anisotropic polymer film for the VA-type liquid crystal display device, the retardation Rth value of the film is preferably from 150 to 400 nm. The VA-type liquid crystal display device may employ an orientation-divided mode described, for example, in JP-A-10-123576.

(IPS-Type Liquid Crystal Display Device and ECB-Type Liquid Crystal Display Device)

The cellulose acylate film of the present invention is advantageously used particularly as the support of an optically-compensatory film or the protective film of a polarizing plate in an IPS-type liquid crystal display device having an IPS-mode liquid crystal cell and an ECB-type liquid crystal display device having an ECB-mode liquid crystal cell. These modes are a mode of causing the liquid crystal material to align nearly in parallel at the black display time, where the liquid crystal molecules are aligned in parallel to the substrate plane in a voltage-unapplied state to provide black display. In these modes, the polarizing plate using the cellulose acylate film of the present invention contributes to improvement of color tint, enlargement of the viewing angle and elevation of the contrast. In these modes, the polarizing plate using the cellulose acylate film of the present invention for the protective film disposed between the liquid crystal cell and the polarizing plate (cell-side protective film) out of the protective films of the polarizing plates above and under the liquid crystal cell is preferably used at least on one side of the liquid crystal cell. More preferably, an optically anisotropic layer is disposed between the polarizing plate protective film and the liquid crystal cell and the retardation value of the optically anisotropic layer disposed is set to 2 times or less the Δn·d value of the liquid crystal layer.

(OCB-Type Liquid Crystal Display Device and HAN-type Liquid Crystal Display Device)

The cellulose acylate film of the present invention is also advantageously used as the support of an optically-compensatory film in an OCB-type liquid crystal display device having an OCB-mode liquid crystal cell and an HAN-type liquid crystal display device having an HAN-mode liquid crystal cell. In the optically-compensatory film used for the OCB-type liquid crystal display device or HAN-type liquid crystal display device, a direction where the absolute value of retardation becomes minimum is preferably present neither in the plane nor in the normal direction of the optically-compensatory film. The optical property of the optically-compensatory film used for the OCB-type liquid crystal display device or HAN-type liquid crystal display device is also determined by the optical property of the optically anisotropic layer, the optical property of the support, and the configuration of the optically anisotropic layer and the support. The optically-compensatory film for use in the OCB-type liquid crystal display device or HAN-type liquid crystal display device is described in JP-A-9-197397 and the article by Mori et al. (Jpn. J. Appl. Phys., Vol. 38, page 2837 (1999)).

(Reflective Liquid Crystal Display Device)

The cellulose acylate film of the present invention is also advantageously used for the optically-compensatory film in a TN-type, STN-type, HAN-type or GH (guest-host)-type reflective liquid crystal display device. These display modes have long been well known. The TN-type reflective liquid crystal display device is described in JP-A-10-123478, International Publication No. 98/48320 and Japanese Patent No. 3022477, and the optically-compensatory film used for the reflective liquid crystal display device is described in International Publication No. 00/65384 pamphlet.

(Other Liquid Crystal Display Devices)

The cellulose acylate film of the present invention is also advantageously used as the support of an optically-compensatory film in an ASM-type liquid crystal display device having an ASM (axially symmetric aligned microcell)-mode liquid crystal cell. The ASM-mode liquid crystal cell is characterized in that the thickness of the cell is maintained by a position-adjustable resin spacer. Other properties are the same as those of the TN-mode liquid crystal cell. The ASM-mode liquid crystal cell and the ASM-type liquid crystal display device are described in the article by Kume et al. {Kume et al., SID 98 Digest, 1089 (1998)}.

[Hardcoat Film, Antiglare Film, Antireflection Film]

The cellulose acylate film of the present invention is also preferably applied to a hardcoat film, an antiglare film or an antireflection film. Any one or all of a hardcoat layer, an antiglare layer and an antireflection layer may be provided on one surface or both surfaces of the cellulose acylate film of the present invention so as to enhance the visibility of a flat panel display such as LCD, PDP, CRT and EL. Preferred embodiments of these antiglare film and antireflection film are described in detail in JIII Journal of Technical Disclosure, No. 2001-1745, pp. 54-57, Japan Institute of Invention and Innovation (Mar. 15, 2001), and the cellulose acylate film of the present invention can be preferably used.

[Photographic Film Support]

The cellulose acylate film of the present invention can also be applied as the support of a silver halide photographic light-sensitive material, and various materials, formulations and processing methods described in patent publications related to the photographic light-sensitive material can be applied. As for these techniques, the color negative film is described in detail in JP-A-2000-105445, and the cellulose acylate film of the invention is preferably used. Application as the support of a color reversal silver halide photographic light-sensitive material is also preferred, and various materials, formulations and processing methods described in JP-A-11-282119 can be applied.

[Transparent Substrate of Liquid Crystal Cell]

The cellulose acylate film of the present invention has optical anisotropy close to zero and has excellent transparency and therefore, this cellulose acylate film can be used as an alternative of the liquid crystal cell glass substrate, that is, a transparent substrate for encapsulating a driving liquid crystal, in a liquid crystal display.

The transparent substrate for encapsulating a liquid crystal needs to have excellent gas barrier property and therefore, if desired, a gas barrier layer may be formed on the surface of the cellulose acylate film of the present invention. The form or construction material of the gas barrier layer is not particularly limited, but a method of vapor-depositing SiO₂ or the like on at least one surface of the cellulose acylate film of the present invention, or a method of providing a coat layer comprising a polymer having relatively high gas barrier property, such as vinylidene chloride-based polymer or vinyl alcohol-based polymer, may be considered, and these techniques can be appropriately used.

Also, in the case of use as the transparent substrate for encapsulating a liquid crystal, a transparent electrode for driving the liquid crystal by voltage application may be provided. The transparent electrode is not particularly limited but can be formed by stacking a metal film, a metal oxide film or the like on at least one surface of the cellulose acylate film of the present invention. Above all, in view of transparency, electrical conductivity and mechanical property, a metal oxide film is preferred, and a thin film of indium oxide mainly comprising tin oxide and containing from 2 to 15 mass % of zinc oxide is more preferred. Details of these technologies are described, for example, in JP-A-2001-125079 and JP-A-2000-227603.

### EXAMPLES

The present invention is described below by referring to Examples, but the present invention is not limited thereto.

<Production of Cellulose Acylate Film>

[Preparation of Acrylic Polymer]

### Preparation Example 1

Polymer (P-11) is prepared by a known synthesis method. Hereinafter, this polymer is called Polymer (P-11-1) (mass average molecular weight: 5,000) or Polymer (P-11-2) (mass average molecular weight: 1,800) by the mass average molecular weight. Polymers (P-11-1) and (P-11-2) each is dissolved in ethyl acetate, the resulting solution is charged into hexane, and the obtained precipitate is collected by filtration. The crystallization step is repeated, whereby modified polymers differing in the content of residual ethylenically unsaturated monomer, shown in the Table below, are obtained. The monomer content is measured by gas chromatography.

TABLE 2

| Acrylic Polymer | | | Name of Modified |
|---|---|---|---|
| | Mass Average | | Polymer After |
| | Molecular | Residual Monomer | Adjusting Residual |
| Kind | Weight | Content (mass %) | Monomer Content |
| P-11-1 | 5,000 | 6.1 | P-11-1A |
| P-11-1 | 5,000 | 3.2 | P-11-1B |
| P-11-1 | 5,000 | 1.8 | P-11-1C |
| P-11-1 | 5,000 | 0.2 | P-11-1D |
| P-11-2 | 1,800 | 5.7 | P-11-2A |
| P-11-2 | 1,800 | 2.1 | P-11-2B |
| P-11-2 | 1,800 | 0.3 | P-11-2C |

[Production of Cellulose Acylate Film]

### Comparative Example 1-1

### [Preparation of Cellulose Acylate Stock Solution (CAL-1)]

The composition shown below is charged into a mixing tank and stirred under heating to dissolve respective components, whereby Cellulose Acylate Stock Solution (CAL-1) is prepared.

{Composition of Cellulose Acylate Stock Solution (CAL-1)}

| | | |
|---|---|---|
| Cellulose acetate having an acetyl | 100 | parts by mass |
| substitution degree of 2.86 and a | | |
| polymerization degree of 310 | | |
| Methylene chloride (first solvent) | 402 | parts by mass |
| Methanol (second solvent) | 60 | parts by mass |

[Preparation of Matting Agent Solution (ML-1)]

The following composition is charged into a disperser and stirred to dissolve respective components, whereby Matting Agent Solution (ML-1) is prepared.

{Composition of Matting Agent Solution (ML-1)}

| | | |
|---|---|---|
| Silica particle liquid dispersion (average | 10.0 | parts by mass |
| particle diameter: 16 nm), “AEROSIL | | |
| R972” produced by Nihon Aerosil Co., Ltd. | | |
| Methylene chloride (first solvent) | 76.3 | parts by mass |
| Methanol (second solvent) | 3.4 | parts by mass |
| Cellulose Acylate Stock Solution (CAL-1) | 10.3 | parts by mass |

[Preparation of Acrylic Polymer Solution A]

The following composition is charged into a separate mixing tank and stirred under heating to dissolve respective components, whereby Solution A containing the polymer of the present invention is prepared.

(Composition of Acrylic Polymer Solution A)

| | | |
|---|---|---|
| Ultraviolet Absorbent (UV-23L) | 2.0 | parts by mass |
| Ultraviolet Absorbent (UV-28L) | 2.0 | parts by mass |
| Polymer (P-11-1A) | 49.3 | parts by mass |
| Methylene chloride (first solvent) | 58.4 | parts by mass |
| Ethanol (second solvent) | 8.7 | parts by mass |
| Cellulose Acylate Stock Solution (CAL-1) | 12.8 | parts by mass |

[Production of Cellulose Acylate Film (101)]

94.6 Parts by mass of Cellulose Acylate Stock Solution (CAL-1), 1.3 parts by mass of Matting Agent Solution (ML-1) and Acrylic Polymer Solution A in an amount such that Ultraviolet Absorbent (UV-23L) and Ultraviolet Absorbent (UV-28L) each accounts for 0.6 parts by mass and Polymer (P-11-1A) of the present invention accounts for 20 parts by mass, per 100 parts by mass of cellulose acylate, are mixed and thoroughly stirred under heating to dissolve respective components, whereby a dope (DP1-1) is prepared. The obtained dope (DP1-1) is cast using a band casting machine, and the film with a residual solvent amount of 26 mass % is peeled off and then dried at 140° C. for 40 minutes to obtain Cellulose Acylate Film Sample (101) having a thickness of 80 μm.

### Examples 1-1 to 1-7 and Comparative Examples 1-2 and 1-3

### [Production of Cellulose Acylate Films (102) to (110)]

Dopes (DP1-2 to DP1-10) are prepared in the same manner as in Comparative Example 1-1 except that in the production of Cellulose Acylate Film (101) of Comparative Example 1-1, Acrylic Polymer Solutions A′, B to F, B′ and F′ prepared by adjusting the kind or amount added of the modified polymer to give the composition shown in Table 3 each is used in place of Acrylic Polymer Solution A and, if desired, the kind or amount of the ultraviolet absorbent is changed. Using each of these dopes, Cellulose Acylate Film Samples (102) to (110) are produced. In all of Cellulose Acylate Film Samples (102) to (110), the film thickness is in the range from 79.5 to 80.5 μm. Also, in all of Samples (101) to (110), the difference between the maximum value and the minimum value of the thickness in a 1 m-square film arbitrarily cut out is 5% or less based on the average thickness value.

### Comparative Examples 1-4 and 1-5

### [Production of Cellulose Acylate Film (111) and (112)]

Dopes (DP1-11 and DP1-12) are prepared in the same manner as in Comparative Example 1-1 except that in the production of Cellulose Acylate Film (101) of Comparative Example 1-1, a known plasticizer is used to give the composition shown in Table 3 in place of using Acrylic Polymer Solution A and, if desired, the kind or amount of the ultraviolet absorbent is changed. Using each of these dopes, Cellulose Acylate Film Samples (111) and (112) are produced. In both of Cellulose Acylate Film Samples (111) and (112), the film thickness is in the range from 79.5 to 80.5 μm. Also, in both of Cellulose Acylate Film Samples (111) and (112), the difference between the maximum value and the minimum value of the thickness in a 1 m-square film arbitrarily cut out is 5% or less based on the average thickness value.

TABLE 3

| | | Cellulose Acylate Film | | | | | | |
|---|---|---|---|---|---|---|---|---|
| | | | Dope | | | | | |
| | | | | Acrylic Polymer Solution | | | | |
| | | | | Modified Polymer | | Ultraviolet Absorbent | | Matting Agent |
| | | | | | Amount Added (parts | | Amount Added (parts | Solution |
| | No. | No. | | Kind | by mass)*¹ | Kind | by mass)*¹ | Kind |
| Comparative | 101 | DP1-1 | A | P-11-1A | 20 | UV-23L/UV-28L | 0.6/0.6 | ML-1 |
| Example 1-1 | | | | | | | | |
| Comparative | 102 | DP1-2 | A′ | P-11-1A | 20 | TN326*²/— | 1.2/— | ML-1 |
| Example 1-2 | | | | | | | | |
| Example 1-1 | 103 | DP1-3 | B | P-11-1B | 20 | UV-23L/UV-28L | 0.6/0.6 | ML-1 |
| Example 1-2 | 104 | DP1-4 | C | P-11-1C | 20 | UV-23L/UV-28L | 0.6/0.6 | ML-1 |
| Example 1-3 | 105 | DP1-5 | D | P-11-1D | 20 | UV-23L/UV-28L | 0.6/0.6 | ML-1 |
| Comparative | 106 | DP1-6 | E | P-11-2A | 20 | UV-23L/UV-28L | 0.6/0.6 | ML-1 |
| Example 1-3 | | | | | | | | |
| Example 1-4 | 107 | DP1-7 | F | P-11-2B | 20 | UV-23L/UV-28L | 0.6/0.6 | ML-1 |
| Example 1-5 | 108 | DP1-8 | G | P-11-2C | 20 | UV-23L/UV-28L | 0.6/0.6 | ML-1 |
| Example 1-6 | 109 | DP1-9 | B′ | P-11-1B | 20 | TN326*²/— | 1.2/— | ML-1 |
| Example 1-7 | 110 | DP1-10 | F′ | P-11-2B | 20 | TN326*²/— | 1.2/— | ML-1 |

| Comparative | 111 | DP1-11 | TPP*³ | 10 | TN326*²/— | 1.2/— | ML-1 |
|---|---|---|---|---|---|---|---|
| Example 1-4 | | | EPEG*⁴ | 5 | | | |
| Comparative | 112 | DP1-12 | TPP*³ | 10 | UV-23L/UV-28L | 0.6/0.6 | ML-1 |
| Example 1-5 | | | EPEG*⁴ | 5 | | | |
| | | | | Amount Added (parts | | Amount Added (parts | |
| | No. | No. | Kind | by mass)*¹ | Kind | by mass)*¹ | Kind |

| | | |
|---|---|---|
| Plasticizer | Ultraviolet Absorbent | Matting Agent |
| | | Solution |

Dope

Cellulose Acylate Film
*¹Parts by mass per 100 parts by mass of cellulose acylate film
*²Produced by Ciba Specialty Chemicals Corp.
*³Triphenyl phosphate
*⁴Ethylphthalyl ethyl glycolate

[Evaluation of Cellulose Acylate Film]
[Quantitative Determination of Residual Monomer in Film]

Low molecular compound are extracted from the produced Cellulose Acylate Film Samples (101) to (112) by using a tetrahydrofuran/methanol mixed solvent, and the residual monomer amount is quantitatively determined by a gas chromatograph. The results are shown in Table 4.

[Measurement of Retardation Properties (Rth and Re)]

Cellulose Acylate Films (101) to (112) obtained are subjected to measurement of retardation properties (Rth and Re) at a wavelength of 630 nm according to the methods described above.

<Production of Polarizing Plate>

### Comparative Example 2-1

A polarizer is produced by adsorbing iodine to a stretched polyvinyl alcohol film.

Subsequently, Cellulose Acylate Film Sample (101) after saponification is laminated to one side of the polarizer by using a polyvinyl alcohol-based adhesive. The slow axis of the transparent support and the transmission axis of the polarizer are arranged to run in parallel.

A commercially available cellulose triacetate film “FUJI-TAC TD80UF” (produced by Fuji Photo Film Co., Ltd.) is saponified similarly to the above and laminated to the opposite side of the polarizer by using a polyvinyl alcohol-based adhesive. In this way Polarizer (H-101) is produced.

### Examples 2-1 to 2-7 and Comparative Examples 2-2 to 2-5

Polarizing Plates (H-102) to (H-112) are prepared in the same manner as in Comparative Example 2-1 except that in the production of Polarizing Plate (H-101) of Comparative Example 2-1, each of Cellulose Acylate Film Samples (102) to (112) is used in place of Cellulose Acylate Film Sample (101).

[Durability of Polarizing Plate]

(Evaluation of White Spot in Edge Part)

Two sheets of a sample in a size of 100 mm×100 mm are cut out from each of Polarizing Plates (H-101) to (H-112) and exposed to an atmosphere of 80° C. and 90% RH for 50 hours, and the area of white spots generated at edges of the polarizing plate due to the cross-Nicol arrangement is observed as an area ratio to the entire area and evaluated according to the following grading.

A: White spots are not observed at all.

B: The area of white spots is less than 5% based on the entire area.

C: The area of white spots is 10% or more based on the entire area.

[Change of Transmittance]

Two sheets of a sample in a size of 50 mm×50 mm are cut out from each of Polarizing Plates (H-101) to (H-112) and aged by exposure to an atmosphere of 60° C. and 95% RH for 1,000 hours. The transmittance of the polarizing plate in a state of being overlapped in a cross-Nicol arrangement is measured before and after the aging, and the change of transmittance at a wavelength of 410 nm is determined.

The data on durability (white spot at edge and change of transmittance) of the polarizing plate obtained are shown in Table 4 together with the kind of the cellulose acylate film used in each polarizing plate.

TABLE 4

| | | Polarizing Plate | | | | | | |
|---|---|---|---|---|---|---|---|---|
| | | | Cellulose Acylate Film | | | | Durability | |
| | | | | Residual Monomer | Retardation Properties | | White Spot at | Change of |
| | No. | | No. | Content (mass %)*⁵ | Re(630) | Rth(630) | Edge | Transmittance (%) |
| Comparative | H-101 | Comparative | 101 | 1.2 | 2 | 0 | A | 4.5 |
| Example 2-1 | | Example 1-1 | | | | | | |
| Comparative | H-102 | Comparative | 102 | 1.2 | 3 | 6 | A | 3.8 |
| Example 2-2 | | Example 1-2 | | | | | | |
| Example 2-1 | H-103 | Example 1-1 | 103 | 0.6 | 2 | 1 | A | 2.1 |
| Example 2-2 | H-104 | Example 1-2 | 104 | 0.4 | 2 | 1 | A | 1.8 |
| Example 2-3 | H-105 | Example 1-3 | 105 | 0.05 | 2 | 0 | A | 1.2 |
| Comparative | H-106 | Comparative | 106 | 1.1 | 2 | 1 | A | 4.2 |
| Example 2-3 | | Example 1-3 | | | | | | |
| Example 2-4 | H-107 | Example 1-4 | 107 | 0.4 | 2 | 1 | A | 1.9 |
| Example 2-5 | H-108 | Example 1-5 | 108 | 0.06 | 2 | 0 | A | 1.2 |
| Example 2-6 | H-109 | Example 1-6 | 109 | 0.6 | 2 | 6 | A | 2.5 |
| Example 2-7 | H-110 | Example 1-7 | 110 | 0.4 | 2 | 6 | A | 2.4 |
| Comparative | H-111 | Comparative | 111 | — | 3 | 45 | B | 2.3 |
| Example 2-4 | | Example 1-4 | | | | | | |
| Comparative | H-112 | Comparative | 112 | — | 3 | 40 | C | 1.9 |
| Example 2-5 | | Example 1-5 | | | | | | |

*⁵Mass % per 100 parts by mass of cellulose acylate film.

As seen from Table 4, the polymer suitably used in the present invention has a high ability of decreasing Rth and at the same time, in regard to the durability of the polarizing plate, exhibits an effect of preventing the edge part from white spotting at a high temperature. However, when the polarizing plate is aged for a long time under high-humidity conditions, the stability of performance in terms of the change of transmittance is insufficient. By virtue of the cellulose acylate film of the present invention where the residual monomer content of the polymer is reduced to 1 mass % or less, low retardation as well as reduced change of transmittance of the polarizing plate can be realized.

[Production of Polarizing Plate with Phase Difference Film]

### Example 3

A norbornene-based resin film “ARTON” {produced by JSR Corp.} is uniaxially stretched and thus produced phase difference film is laminated to the Cellulose Acylate Film (104) side of Polarizing Plate (H-104) by using an adhesive to produce a polarizing plate with phase difference film. At this time, the slow axis of the in-plane retardation of the phase difference film and the transmission axis of the polarizing plate are arranged to cross at right angles, whereby the visual characteristics can be enhanced without causing any change in the front characteristics. A phase difference film in which the in-plane retardation Re is 270 nm, the retardation in the thickness direction is 0 nm, and the Nz factor is 0.5, is used.

[Evaluation of Mounting in IPS Liquid Crystal Display Device]

### Example 4

Using two sets of the polarizing plate with phase retardation film produced in Example 3, a display device in which a polarizing plate with retardation film, an IPS-mode liquid crystal cell and a polarizing plate with phase difference film are incorporated by stacking these in this order from above such that each phase retardation film comes to the liquid crystal cell side, is produced. At this time, the transmission axes of upper and lower polarizing plates with phase difference film are arranged to cross at right angles, and the transmission axis of the upper polarizing plate with phase difference film is arranged in parallel to the molecular long axis direction of the liquid crystal cell (that is, the slow axis of the phase difference film and the molecular long axis direction of the liquid crystal cell are orthogonal to each other). As for the liquid crystal cell and electrode•substrate, those conventionally used as IPS can be used directly. The liquid crystal cell is oriented in the horizontal alignment, and as for the liquid crystal, those having positive dielectric anisotropy and being developed and commercially available for IPS liquid crystal may be used. The liquid crystal cell is set to have physical properties that Δn of liquid crystal: 0.099, cell gap of liquid crystal layer: 3.0 μm, pretilt angle: 5°, and rubbing direction: 75° for both upper and lower substrates.

In the thus-produced liquid crystal display device, the light leakage rate in the azimuthal angle direction of 45° from the front of the device and the polar angle direction of 70° at the black display time is measured, as a result, the polarizing plate with phase difference film produced using the cellulose acylate film of the present invention is found good with a wide contrast-viewing angle.

### Comparative Example 5-1 and Example 5-1

### [Preparation of Acrylic Polymer (P-2)]

Acrylic Polymer (P-2) having a mass average molecular weight of 1,700 is obtained by a known synthesis method similarly to Acrylic Polymer (P-11) in Preparation Example 1. Polymers (P-2A) and (P-2B) differing in the residual monomer content are obtained by changing the crystallization step.

[Production of Cellulose Acylate Film Samples (501) and (502)]

Cellulose Acylate Film Samples (501) and (502) are produced in the same manner except that Polymer (P-11-1A) in Sample (101) of Comparative Example 1-1 is changed to Polymer (P-2A) or (P-2B). The residual monomer amount in the cellulose acylate film is 1.2 mass % in Sample (501) and 0.1 mass % in Sample (502) (both are a value per 100 parts by mass of cellulose acylate film). Here, the residual monomer amount is calculated by a value totaling two kinds of monomers.

Cellulose Acylate Film Samples (501) and (502) are subjected to measurement of retardation properties (Rth and Re) of cellulose acylate in the same manner as in Example 1. The results are shown in Table 5.

### Comparative Example 6-1 and Example 6-1

### [Production and Evaluation of Polarizing Plate]

Polarizing Plates (H-501) and (H-502) are produced in the same manner as in Example 2 by using Cellulose Acylate Film Samples (501) and (502), respectively, and the durability thereof is evaluated. The results are shown in Table 5.

TABLE 5

| | | Polarizing Plate | | | | | | |
|---|---|---|---|---|---|---|---|---|
| | | | Cellulose Acylate Film | | | | | |
| | | | | Residual Monomer | Retardation Properties | | White Spot at | Change of |
| | No. | | No. | Content (mass %)*⁵ | Re(630) | Rth(630) | Edge | Transmittance (%) |
| Comparative | H-501 | Comparative | 501 | 1.2 | 3 | 1 | A | 4.8 |
| Example 6-1 | | Example 5-1 | | | | | | |
| Example 6-1 | H-502 | Example 5-1 | 502 | 0.1 | 2 | 1 | A | 1.3 |

*⁵Mass % per 100 parts by mass of cellulose acylate film.

It is seen from Table 5 that a film containing Polymer (P-2) can also be reduced in the optical properties. Furthermore, the change of transmittance of the polarizing plate can be reduced by decreasing the residual monomer amount.

### Comparative Example 7-1 and Examples 7-1 and 7-2

Condensation polymer PE-1 (number average molecular weight: 2,000) is synthesized by a known method to prepare PE-1A and PE-1B, of which low molecular component content is varied by reduced-pressure distillation.

Cellulose Acylate Film Samples (701) and (702) are produced in the same manner as in Example 1-1 except that Polymer P-11-1B is replaced by a 1-fold mass of PE-1A or PE-1B. Also, Cellulose Acylate Film Sample (703) is produced in the same manner as in Sample (702) except that the ultraviolet absorbents UV-23L and UV-28L which are in a liquid state at 25° C. are replaced by a 1-flod mass of TN326 which is in a solid state at 25° C. The low molecular ester content per film and the retardation properties are shown in Table 6.

### Comparative Example 8-1 and Examples 8-1 and 8-2

Also, Polarizing Plates (H-801), (H-802) and (H803) are produced in the same manner as above by using Film Samples (701), (702) and (703), respectively, and the durability thereof is evaluated. The results are shown in Table 6.

TABLE 6

| | | Polarizing Plate | | | | | | | | |
|---|---|---|---|---|---|---|---|---|---|---|
| | | | Cellulose Acylate Film | | | | | | | |
| | | | | | Low Molecular | | Retardation | | White | Change of |
| | | | | Condensation | Ester Content | Ultraviolet | Properties | | Spot at | Transmittance |
| | No. | | No. | Polymer | (mass %)*⁵ | Absorbent | Re(630) | Rth(630) | Edge | (%) |
| Comparative | H-801 | Comparative | 701 | PE-1A | 1.5 | UV-23L/UV-28L | 2 | 7 | B | 4.5 |
| Example 8-1 | | Example 7-1 | | | | | | | | |
| Example 8-1 | H-802 | Example 7-1 | 702 | PE-1B | 0.2 | UV-23L/UV-28L | 2 | 7 | A | 1.2 |
| Example 8-2 | H-803 | Example 7-2 | 703 | PE-1B | 0.2 | TN326 | 2 | 7 | A | 2.3 |

*⁵Mass % per 100 parts by mass of cellulose acylate film.

It is seen from Table 6 that a film containing Condensation polymer (PE-1) can also be reduced in the optical properties. Furthermore, the white spot and change of transmittance of the polarizing plate can be reduced by decreasing the low molecular ester amount. Moreover, the change of transmittance can be reduced by employing the ultraviolet absorbents which are liquid at 25° C.

As a result of studies by the present inventors, a cellulose acylate film having small optical anisotropy Re and Rth can be produced, and an optical material using the cellulose acylate film, such as optically-compensatory film and polarizing plate, and a liquid crystal display device using such an optical material can be provided. Furthermore, an excellent polarizing plate assured of less deterioration of the polarizer in aging of a long time under a high-humidity condition can be provided.

The entire disclosure of each and every foreign patent application from which the benefit of foreign priority has been claimed in the present application is incorporated herein by reference, as if fully set forth.

What is claimed is:

1. A cellulose acylate film comprising:
a cellulose acylate;
a polymer obtained by polymerizing an ethylenically unsaturated monomer; and
an unreacted ethylenically unsaturated monomer in an amount of 1 mass % or less based on the cellulose acylate film.

2. The cellulose acylate film according to claim 1,
wherein the polymer is an acrylic polymer.

3. A cellulose acylate film comprising:
a cellulose acylate;
a condensation polymer selected from the group consisting of a condensation polymer obtained by polycondensing an organic acid, a glycol and a monohydric alcohol and a condensation polymer obtained by polycondensing an organic acid and a glycol; and
a low-molecular ester compound in an amount of 1 mass % or less based on the cellulose acylate film,
wherein the low-molecular ester compound is obtained by condensing five or less molecules which are raw materials of the condensation polymer.

4. The cellulose acylate film according to claim 1, further comprising:
an ultraviolet absorbent that is in a liquid state at 25° C.

5. The cellulose acylate film according to claim 3, further comprising:
an ultraviolet absorbent that is in a liquid state at 25° C.

6. The cellulose acylate film according to claim 1,
wherein the cellulose acylate has an acyl substitution degree of 2.50 to 3.00 and an average polymerization degree of 180 to 700.

7. The cellulose acylate film according to claim 3,
wherein the cellulose acylate has an acyl substitution degree of 2.50 to 3.00 and an average polymerization degree of 180 to 700.

8. The cellulose acylate film according to claim 1,
wherein substantially all acyl substituents of the cellulose acylate are acetyl groups; and
the cellulose acylate has an acyl substitution degree of 2.50 to 2.95 and an average polymerization degree of 180 to 550.

9. The cellulose acylate film according to claim 3,
wherein substantially all acyl substituents of the cellulose acylate are acetyl groups; and
the cellulose acylate has an acyl substitution degree of 2.50 to 2.95 and an average polymerization degree of 180 to 550.

10. The cellulose acylate film according to claim 1, which has a thickness of from 10 to 120 μm.

11. The cellulose acylate film according to claim 3, which has a thickness of from 10 to 120 μm.

12. The cellulose acylate film according to claim 1, which satisfies the following formulae (1) and (2):
−25 nm≦Rth(630)≦25 nm Formula (1):
0 nm≦Re(630)≦10 nm, Formula (2):
wherein Rth(630) represents a retardation in a thickness direction of the cellulose acylate film at a wavelength of 630 nm; and
Re(630) represents an in-plane retardation of the cellulose acylate film at a wavelength of 630 nm.

13. The cellulose acylate film according to claim 3, which satisfies the following formulae (1) and (2):
−25 nm≦Rth(630)≦25 nm Formula (1):
0 nm≦Re(630)≦10 nm, Formula (2):
wherein Rth(630) represents a retardation in a thickness direction of the cellulose acylate film at a wavelength of 630 nm; and
Re(630) represents an in-plane retardation of the cellulose acylate film at a wavelength of 630 nm.

14. A polarizing plate comprising:
a polarizer; and
a pair of protective films between which the polarizer is sandwiched,
wherein at least one of the protective films is the cellulose acylate film according to claim 1.

15. A polarizing plate comprising:
a polarizer; and
a pair of protective films between which the polarizer is sandwiched,
wherein at least one of the protective films is the cellulose acylate film according to claim 3.

16. A liquid crystal display device comprising:
a liquid crystal cell; and
two polarizing plates disposed on both sides of the liquid crystal cell,
wherein at least one of the polarizing plates is the polarizing plate according to claim 14.

17. A liquid crystal display device comprising:
a liquid crystal cell; and
two polarizing plates disposed on both sides of the liquid crystal cell,
wherein at least one of the polarizing plates is the polarizing plate according to claim 15.

18. The liquid crystal display device according to claim 16, which is an IPS-mode liquid crystal display device.

19. The liquid crystal display device according to claim 17, which is an IPS-mode liquid crystal display device.
